(19) United States
(12) Patent Application Publication
(10) Pub. No.: US 2025/0189758 A1
(43) Pub. Date: Jun. 12, 2025

(54) LENS BARREL AND CAMERA SYSTEM EQUIPPED WITH SAME

(71) Applicant: Panasonic Intellectual Property Management Co., Ltd., Osaka (JP)

(72) Inventors: Fumio SHINANO, Osaka (JP); Manabu KOBAYASHI, Osaka (JP)

(73) Assignee: Panasonic Intellectual Property Management Co., Ltd., Osaka (JP)

(21) Appl. No.: 18/967,822

(22) Filed: Dec. 4, 2024

(30) Foreign Application Priority Data
Dec. 11, 2023 (JP) 2023-208742
Oct. 29, 2024 (JP) 2024-189953

(51) Int. Cl. G02B 7/14; G03B 17/14; G03B 17/56

(52) U.S. Cl. CPC G02B 7/14; G03B 17/14; G03B 17/565

(57) ABSTRACT

A lens barrel (10) comprises a lens mount unit (20a), a retractable lens frame (18b), a seventh lens group unit (18), three cam pins (18ad), guide shafts (18af), a pressing member (18d), and a compression spring (18ag). At least two of the guide shafts (18af) are provided to the seventh group unit (18) and are disposed in the optical axis (X). The compression spring (18ag) applies a biasing force that biases the retractable lens frame (18b) against the pressing member (18d) in the optical axis (X) direction, and expands and contracts when a teleconverter (30) is mounted to the lens mount unit (20a), causing the retractable lens frame (18b) to retract to the subject side in the optical axis (X) direction.

### CROSS REFERENCE TO RELATED APPLICATIONS

This application claims priority to Japanese Patent Applications No. 2023-208742 filed on Dec. 11, 2023 and No. 2024-189953 filed on Oct. 29, 2024. The entire disclosure of Japanese Patent Applications No. 2023-208742 and 2024-189953 are hereby incorporated herein by reference.

### BACKGROUND

### Technical Field

The present disclosure relates to a lens barrel and to a camera system equipped with the same.

### Description of the Related Art

Lens barrels that are equipped with an optical system including a plurality of lenses and are interchangeably mounted to a camera body have been in use in recent years. A teleconverter is sometimes mounted between the lens barrel and the camera body to extend the focal length.

A teleconverter can extend the focal length of the lens barrel when mounted to both the mounting portion of the camera body and the mounting portion of the lens barrel.

When a teleconverter is used, there is a risk that members on the teleconverter side will interfere with the member provided closest to the camera body in the optical axis direction of the lens barrel, resulting in damage to that part.

For example, Patent Literature 1 discloses a zoom lens barrel in which, in order to prevent deterioration of the optical performance of a photographic optical system due to external forces exerted on the lens barrel, the cam ring is made up of a lens support ring portion in which an inner cam groove is formed, and a distal end outer peripheral ring portion consisting of a separate member from that of the lens support ring portion and supported on the outer periphery of the distal end portion of the lens support ring portion so as to rotate together in the rotational direction, the distal end outer peripheral ring portion is supported with clearance in the optical axis direction relative to the lens support ring portion, the distal end outer peripheral ring portion is biased to move in the optical axis direction in the clearance portion in the optical axis direction between the distal end outer peripheral ring portion and the lens support ring portion, and a biasing spring that bends when an external force is exerted from outside the barrel is attached to the distal end outer peripheral ring portion.

### CITATION LIST

### Patent Literature

Patent Literature 1: JP-A 2001-215389

### SUMMARY

### Problem to be Solved by the Invention

However, the following problem is encountered with the above-mentioned conventional zoom lens barrel.

The zoom lens barrel disclosed in the above publication employs a configuration such that when an external force is exerted on the outer tube, a compression spring contracts and a second cam tube is displaced, which prevents damage to an internal lens frame, while a rotation stopper affords retraction in just the optical axis direction.

However, with a configuration such as this, when the teleconverter is mounted between the camera body and the lens barrel, the members on the teleconverter side and the lens frame on the lens barrel side may interfere with each other in the optical axis direction, which can result cause damage to parts or other such problems.

It is an object of the present disclosure to provide a lens barrel equipped with a lens drive frame that is driven in the optical axis direction by three cam pins, and with which damage to parts and other such problems can be avoided even when a teleconverter is mounted, as well as a camera system equipped with this lens barrel.

### Means for Solving Problem

The lens barrel according to the present disclosure is a lens barrel that is interchangeably mounted to a camera body, and includes a mounting portion, a retractable lens frame, a lens drive frame, three cam pins, guide shafts, a pressing member, and a biasing member. A teleconverter is mounted to the mounting portion. The retractable lens frame includes an optical lens that interferes in the optical axis direction when the teleconverter is mounted. The lens drive frame encompasses the retractable lens frame. The three cam pins are provided to the lens drive frame and protrude in a direction intersecting the optical axis direction. At least two guide shafts are provided to the lens drive frame and are disposed along the optical axis direction. The pressing member is attached on the image plane side of the lens drive frame and restricts movement of the retractable lens frame to the image plane side in the optical axis direction. The biasing member is attached along the guide shafts and imparts a biasing force that biases the retractable lens frame against the pressing member in the optical axis direction, and expands and contracts when the teleconverter is mounted to the mounting portion so as to retract the retractable lens frame to the subject side in the optical axis direction.

### Effects

With the lens barrel of the present disclosure, in a configuration including a lens drive frame that is driven in the optical axis direction by three cam pins, damage to parts and other such problems can be avoided even when a teleconverter is mounted.

### BRIEF DESCRIPTION OF THE DRAWINGS

FIG. 1A is a side view of the external configuration of a lens barrel according to an embodiment of the present disclosure;

FIG. 1B is a side view of a state in which a teleconverter has been attached to the end on the image plane side of the lens barrel in FIG. 1A;

FIG. 2A is a cross-sectional view of the internal configuration of the lens barrel in FIG. 1A;

FIG. 2B is a cross-sectional view of the internal configuration of the lens barrel in FIG. 1B;

FIG. 3A is a cross-sectional view of a state in which the optical system of the lens barrel to which the teleconverter has been mounted as in FIG. 1B is on the wide-angle side (WIDE side position);

FIG. 3B is a cross-sectional view of a state in which the optical system of the lens barrel to which the teleconverter has been mounted as in FIG. 1B is on the telephoto side (telephoto position);

FIG. 4 is an exploded oblique view showing the configuration of the lens barrel in FIG. 1A;

FIG. 5A is an oblique view of the configuration on the subject side of a seventh lens group unit included in the lens barrel in FIG. 3;

FIG. 5B is an oblique view of the configuration on the image plane side of the seventh lens group unit included in the lens barrel in FIG. 3;

FIG. 6 is an exploded oblique view of the configuration of the seventh lens group unit in FIG. 5A, etc.;

FIG. 7 is a front view of the seventh lens group unit in FIG. 5A, etc., as seen from the subject side;

FIG. 8A is a cross-sectional view along the E-E line in FIG. 7;

FIG. 8B is a cross-sectional view of a state in which the seventh lens group unit in FIG. 7 is in its retracted position due to the mounting of a teleconverter;

FIG. 9 is a detail view of the A portion in FIG. 8A;

FIG. 10 is a front view of the layout of guide shafts in the retractable lens frame included in the seventh lens group unit in FIG. 7A, etc.;

FIG. 11 is an exploded oblique view of a zoom limit switch attached to the outer peripheral surface of a zoom ring unit attached to the outer peripheral surface of the ring mount base unit in FIG. 3;

FIG. 12 is a side view of the zoom limit switch and the zoom rotation detecting encoder shown in FIG. 11;

FIG. 13 is a side view showing a state in which the zoom ring has been removed from the lens barrel in FIG. 12;

FIG. 14 is an oblique view of the zoom ring, zoom ring rubber, zoom limit switch, etc., constituting the zoom ring unit attached to the outer peripheral surface of the ring mount base unit in FIG. 12;

FIG. 15 is an oblique view showing the state of just the zoom ring in FIG. 14;

FIG. 16 is a detail view of the B portion in FIG. 15;

FIG. 17A is an oblique view of the configuration of a switch unit included in the zoom limit switch shown in FIG. 12, etc.;

FIG. 17B is an oblique view of the zoom limit switch in FIG. 17A as seen from the bottom side;

FIG. 18 is a cross-sectional view of a restriction member when the zoom limit switch in FIG. 12, etc., is in an ON state (rotation restricted state);

FIG. 19 is a cross-sectional view of the restriction member when the zoom limit switch in FIG. 18 is in an OFF state (free rotation state);

FIG. 20 is a cross-sectional view of the state of a leaf spring when the zoom limit switch in FIG. 12 etc., is in an ON state;

FIG. 21 is a cross-sectional view of the state of the leaf spring when the zoom limit switch in FIG. 12 etc., is in an OFF state;

FIG. 22 is a rear view of the configuration of the lens barrel in FIG. 1A on the side where a teleconverter is mounted;

FIG. 23A is a side view of the teleconverter mounted on the image plane side of the lens barrel in FIG. 1B;

FIG. 23B is a front view of the configuration on side of the teleconverter in FIG. 23A that is connected to the lens barrel;

FIG. 24 is a control block diagram of the configuration of a camera system including the lens barrel, teleconverter, and camera body in FIG. 1B;

FIG. 25A is an oblique view of the configuration on the subject side of the seventh lens group unit included in the lens barrel according to another embodiment of the present disclosure;

FIG. 25B is an oblique view of the configuration on the image plane side of the seventh lens group unit in FIG. 25A;

FIG. 26 is a front view of the seventh lens group unit in FIG. 25A, etc., as seen from the subject side;

FIG. 27 is a front view of the layout of guide shafts in the retractable lens frame included in the seventh lens group unit in FIG. 25A, etc.;

FIG. 28A is a cross-sectional view along the F-F line in FIG. 26;

FIG. 28B is a cross-sectional view along the G-G line in FIG. 26;

FIG. 29 is an overall oblique view of the configuration of the lens barrel according to yet another embodiment of the present disclosure;

FIG. 30 is an exploded oblique view of the configuration of a stopper, etc., provided on the camera body side of the ring mount base of the lens barrel in FIG. 29;

FIG. 31 is an exploded oblique view of the configuration on the camera body side of the lens barrel in FIG. 29;

FIG. 32 is an overall oblique view of the configuration of a cam barrel included in the lens barrel in FIG. 31;

FIG. 33 is a cross-sectional view of the configuration of a groove formed in the cam barrel in FIG. 32;

FIG. 34A is a cross-sectional view of the restriction member when the zoom limit switch included in the configuration shown in FIG. 31 is in an ON state (rotation restricted state);

FIG. 34B is a cross-sectional view of the state of the stopper when the zoom limit switch shown in FIG. 34A is in an ON state (rotation restricted state);

FIG. 35A is a cross-sectional view of the restriction member when the zoom limit switch included in the configuration shown in FIG. 31 is in an OFF state (free rotation state);

FIG. 35B is a cross-sectional view of the state of the stopper when the zoom limit switch shown in FIG. 35A is in an OFF state (free rotation state);

FIG. 36 is an overall oblique view of the configuration of the lens barrel according to yet another embodiment of the present disclosure;

FIG. 37 is an exploded oblique view of the configuration of the zoom limit switch attached as a unit to a rear frame unit of the lens barrel in FIG. 36;

FIG. 38 is an exploded oblique view of the configuration of the zoom limit switch in FIG. 37;

FIG. 39 is an overall oblique view of the configuration of the cam barrel included in the lens barrel of FIG. 36;

FIG. 40 is a cross-sectional view of the configuration of a groove formed in the cam barrel of FIG. 39;

FIG. 41A is a cross-sectional view of the restriction member when the zoom limit switch shown in FIG. 38 in an ON state (rotation restricted state);

FIG. 41B is a cross-sectional view of the state of the stopper when the zoom limit switch shown in FIG. 41A is in an ON state (rotation restricted state);

FIG. 42A is a cross-sectional view of the restriction member when the zoom limit switch shown in FIG. 38 is in an OFF state (free rotation state); and

FIG. 42B is a cross-sectional view of the state of the stopper when the zoom limit switch shown in FIG. 42A is in an OFF state (free rotation state).

### DETAILED DESCRIPTION OF THE EMBODIMENT

Embodiments will now be described through reference to the drawings. However, some unnecessarily detailed description may be omitted. For example, detailed description of already known facts or redundant description of components that are substantially the same may be omitted. This is to avoid unnecessary repetition in the following description, and facilitate an understanding on the part of a person skilled in the art.

The applicant has provided the appended drawings and the following description so that a person skilled in the art might fully understand this disclosure, but does not intend for these to limit what is discussed in the patent claims.

### Embodiment 1

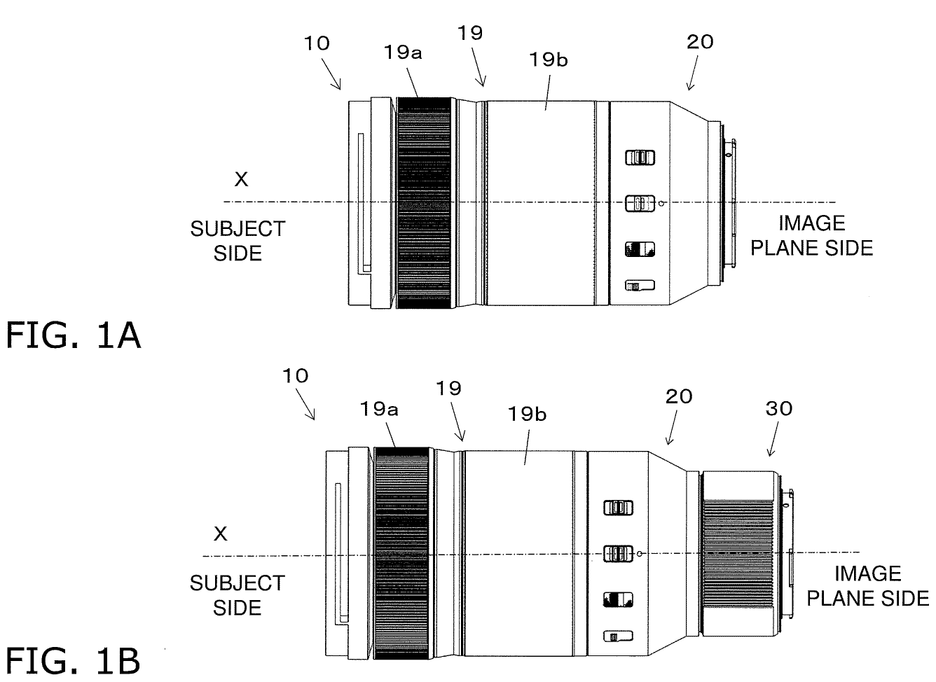

A lens barrel 10 according to an embodiment of the present disclosure and a camera system 100 equipped with the same will now be described through reference to FIGS. 1 to 24.

### (1) Configuration of Lens Barrel 10

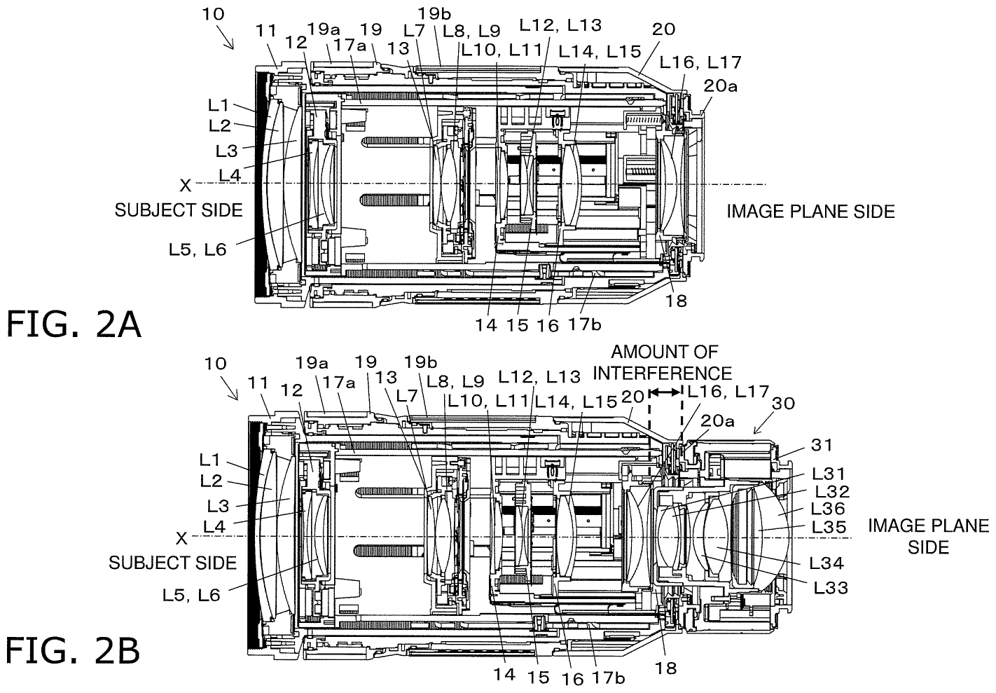

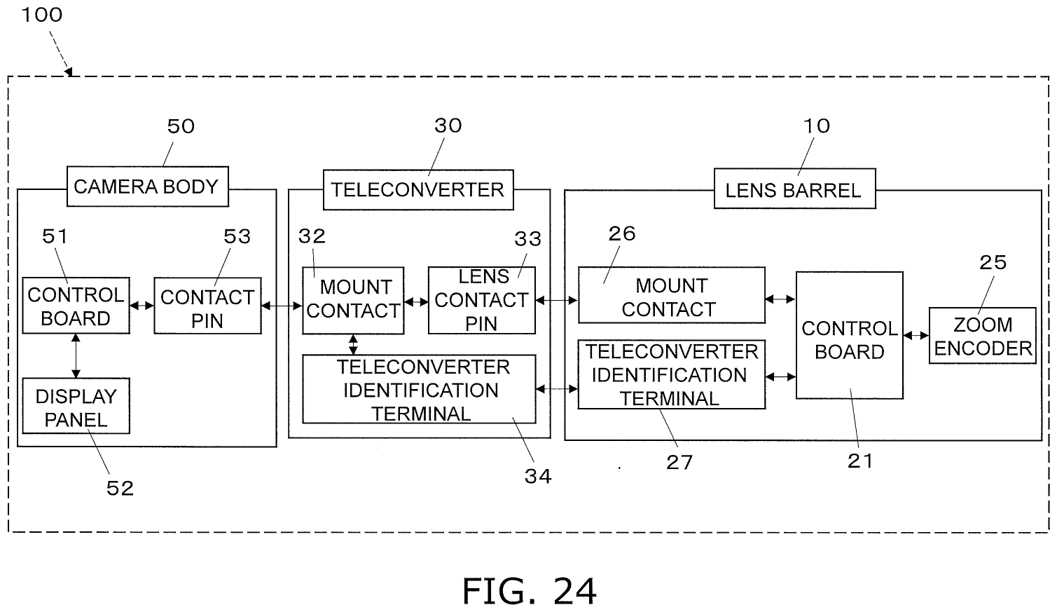

As shown in FIG. 1A, the lens barrel 10 according to this embodiment is removably mounted to a mounting portion of a camera body 50 (see FIG. 24). As shown in FIG. 1B, a teleconverter 30 (discussed below) is mounted to the mounting portion of the camera body 50 in a state in which the teleconverter 30 (discussed below) has been removably mounted on the image plane side, thereby constituting the camera system 100 (see FIG. 24). The lens barrel 10 has an optical system (lenses L1 to L17 (see FIGS. 2A and 2B, etc.)) that guides a subject image to an imaging element provided on the camera body 50 side.

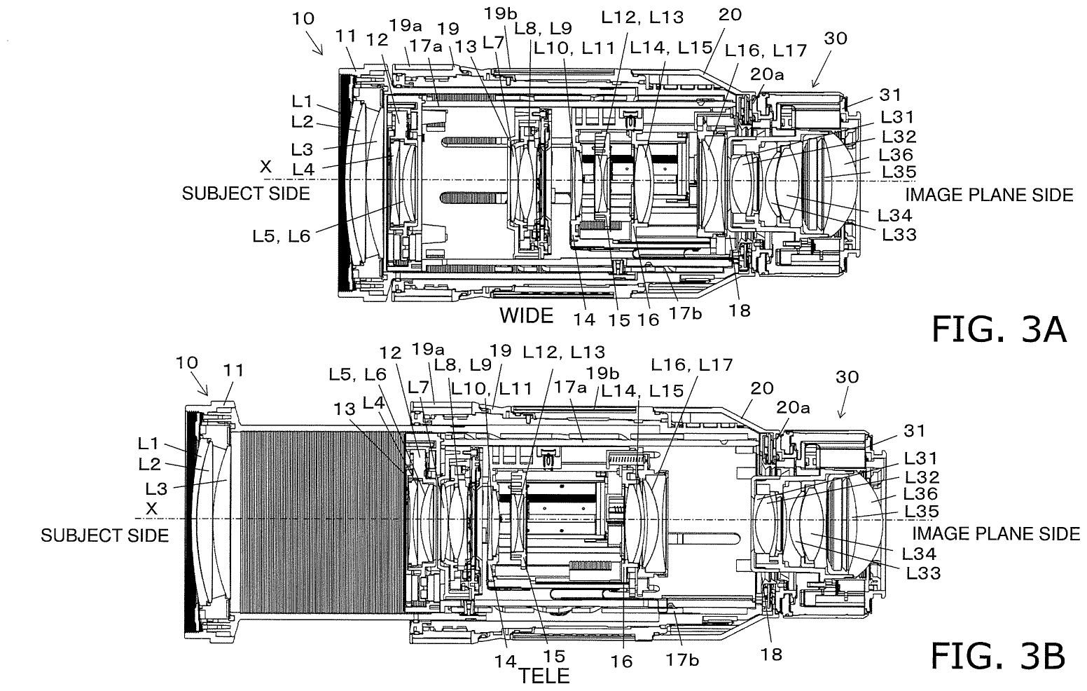

Also, as shown in FIGS. 3A and 3B, the lens barrel 10 can perform variable magnification photography by moving the built-in optical system between the wide-angle side (WIDE side position) and the telephoto side (TELE side position).

When the lens barrel 10 is in the WIDE side position shown in FIG. 3A, a first lens group unit 11 is housed on the inner peripheral surface side of a ring mount base 19.

On the other hand, when the lens barrel 10 is in the TELE side position shown in FIG. 3B, the first lens group unit 11 advances toward the subject side along the optical axis X direction and protrudes from the ring mount base 19 toward the subject.

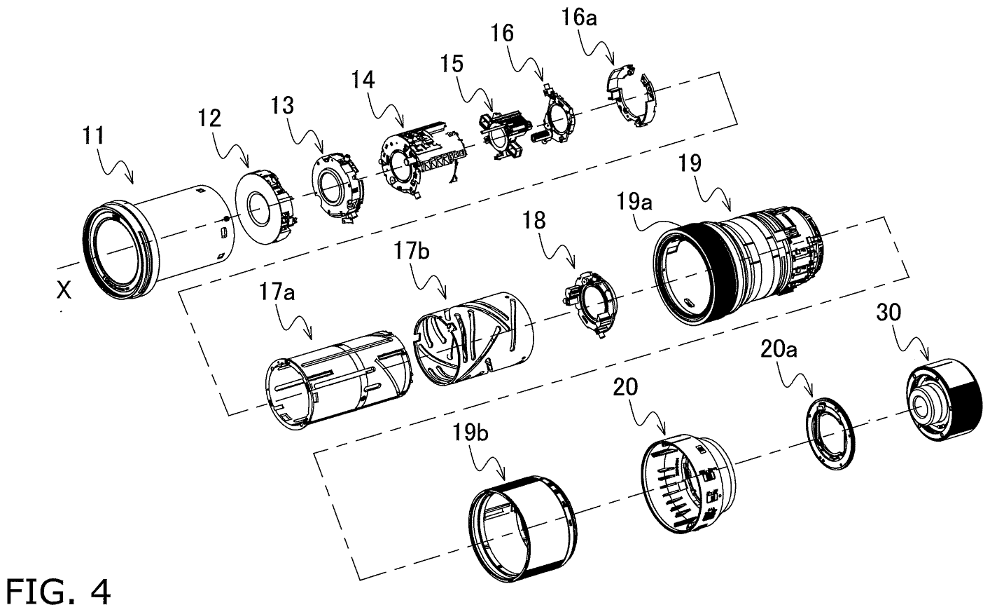

As shown in FIG. 4, the lens barrel 10 includes an optical system made up of a first lens group unit 11, a second lens group unit 12, a third lens group unit 13, a fourth lens group unit 14, a fifth lens group unit 15, a sixth lens group unit 16, a shaft holder 16a, a rectilinear cam barrel 17a, a cam barrel 17b, a seventh lens group unit 18, a ring mount base 19 (base member), a zoom ring unit 19b (manual operation ring), a rear frame unit 20, a lens mount unit 20a, a control board 21, and a plurality of lenses L1 to L17. The teleconverter 30 is mounted to the lens barrel 10 between the camera body 50 and the ends of the lenses L1 to L17 on the opposite side from the subject side in the optical axis X direction (the lens mount unit 20a side).

As shown in FIG. 4, the first lens group unit 11 is a substantially cylindrical resin member that is disposed closest to the subject in the lens barrel 10. As shown in FIGS. 2A, 2B, etc., first lens group unit 11 moves forward and backward along the optical axis X in a state in which the lenses L1 to L3 are held on the subject side. This varies the distance between lenses L1 to L17, allowing wide-angle and telephoto zooming to be performed.

The first lens group unit 11 is mounted on the inner peripheral surface side of the ring mount base 19 in a state of encompassing the second lens group unit 12 to the seventh lens group unit 18, the rectilinear cam barrel 17a, and the cam barrel 17b.

As shown in FIG. 4, second lens group unit 12 is a substantially cylindrical resin member that is disposed on the inner peripheral surface side of first lens group unit 11, and holds the lenses L4 to L6 as shown in FIGS. 2A, 2B, etc. The second lens group unit 12 moves forward and backward along the optical axis X direction as shown in FIGS. 3A and 3B.

As shown in FIG. 4, third lens group unit 13 is a substantially cylindrical resin member that is disposed on the inner peripheral surface side of first lens group unit 11, and is disposed on the image plane side of second lens group unit 12 in the optical axis X direction. The third lens group unit 13 holds the lenses L7 to L9 as shown in FIGS. 2A, 2B, etc. The third lens group unit 13 moves forward and backward along the optical axis X direction as shown in FIGS. 3A and 3B.

As shown in FIG. 4, the fourth lens group unit 14 is a substantially cylindrical resin member that is disposed on the inner peripheral surface side of the first lens group unit 11, and is disposed on the image plane side of the third lens group unit 13 in the optical axis X direction. As shown in FIGS. 2A, 2B, etc., the fourth lens group unit 14 holds the lenses L10 and L11. As shown in FIGS. 3A and 3B, the fourth lens group unit 14 moves forward and backward along the optical axis X direction.

As shown in FIG. 4, the fifth lens group unit 15 is a substantially disk-shaped resin member that is disposed on the inner peripheral surface side of the first lens group unit 11, and is disposed on the inner peripheral side of the fourth lens group unit 14 and on the image plane side of the lenses L10 and L11 in the optical axis X direction. As shown in FIGS. 2A, 2B, etc., the fifth lens group unit 15 holds the lenses L12 and L13. As shown in FIGS. 3A and 3B, the fifth lens group unit 15 moves forward and backward along the optical axis X direction.

As shown in FIG. 4, the sixth lens group unit 16 is a substantially disk-shaped resin member that is disposed on the inner peripheral surface side of the first lens group unit 11, and is disposed inside the fourth lens group unit 14 and on the image plane side of the fifth lens group unit 15 in the optical axis X direction. As shown in FIGS. 2A, 2B, etc., the sixth lens group unit 16 holds the lenses L14 and L15. As shown in FIGS. 3A and 3B, the sixth lens group unit 16 moves forward and backward along the optical axis X direction.

As shown in FIG. 4, the shaft holder 16a is disposed on the image plane side of the sixth lens group unit 16 in the optical axis X direction, and holds the ends of the guide shafts on the image plane side when the fifth lens group unit 15 and the like are driven back and forth in the optical axis X direction.

As shown in FIG. 4, the rectilinear cam barrel 17a is a substantially cylindrical resin member having rectilinear grooves formed along the optical axis X direction, and is disposed on the inner peripheral surface side of the first lens group unit 11 as shown in FIGS. 3A and 3B.

As shown in FIG. 4, the cam barrel 17b is a substantially cylindrical metal member having a cam groove formed along a direction intersecting the optical axis X direction, and as shown in FIGS. 3A and 3B, the cam barrel 17b is disposed on the inner peripheral surface side of the first lens group unit 11 in a state of being mounted on the outer peripheral side of the rectilinear cam barrel 17a.

Cam pins of the fourth lens group unit 14, the fifth lens group unit 15, the sixth lens group unit 16, the seventh lens group unit 18, etc., are fitted into the rectilinear grooves of the rectilinear cam barrel 17a and the cam grooves of the cam barrel 17b.

Consequently, when a rotational drive force is applied from a rotational drive source (not shown), the cam pins, etc., move along the cam grooves, allowing the first lens group unit 11 to the seventh lens group unit 18 to be moved back and forth in the optical axis X direction. Therefore, wide-angle photography, telephoto photography, and the like can be performed by adjusting the distance between the lenses L1 to L17 included in the first lens group unit 11 to the seventh lens group unit 18.

As shown in FIG. 4, the seventh lens group unit 18 is a substantially disk-shaped resin member that is disposed on the inner peripheral surface side of the rectilinear cam barrel 17a and the cam barrel 17b on the inner peripheral surface side of the first lens group unit 11, and is disposed on the image plane side of the fifth lens group unit 15 and the sixth lens group unit 16 in the optical axis X direction. As shown in FIGS. 2A, 2B, etc., the seventh lens group unit 18 holds the lenses L16 and L17. And as shown in FIGS. 3A and 3B, the seventh lens group unit 18 moves forward and backward along the optical axis X direction.

The detailed configuration of the seventh lens group unit 18 will be discussed below.

As shown in FIGS. 1A, 4, etc., the ring mount base 19 (base member) is a cylindrical resin member that constitutes the exterior portion of the lens barrel 10, and an annular focus ring 19a, a zoom ring unit 19b, etc., are rotatably attached to the outer peripheral surface.

The focus ring 19a is a cylindrical member that is rotatably attached on the subject side of the outer peripheral surface of the ring mount base 19, and is rotated when the focus mechanism is made to function by varying the relative positions of the plurality of lenses.

The zoom ring unit 19b (manual operation ring) is a cylindrical member that is rotatably attached on the image plane side of the outer peripheral surface of the ring mount base 19, and is rotated when performing a zoom operation by varying the relative positions of the plurality of lenses.

The rotational operation of the zoom ring unit 19b is restricted by a zoom limit switch 40 (rotation restriction portion) discussed below. The restriction of rotation by the zoom limit switch 40 will be described in detail below.

The rear frame unit 20 is attached to the end of the ring mount base 19 on the image plane side, and together with the ring mount base 19 constitutes the exterior part of the lens barrel 10. The rear frame unit 20 is attached so as not to rotate with respect to the ring mount base 19.

As shown in FIG. 4, the lens mount unit (mounting portion) 20a is a substantially disk-shaped member that serves as a base to which the teleconverter 30 or the camera body 50 is connected, and is attached on the image plane side of the rear frame unit 20.

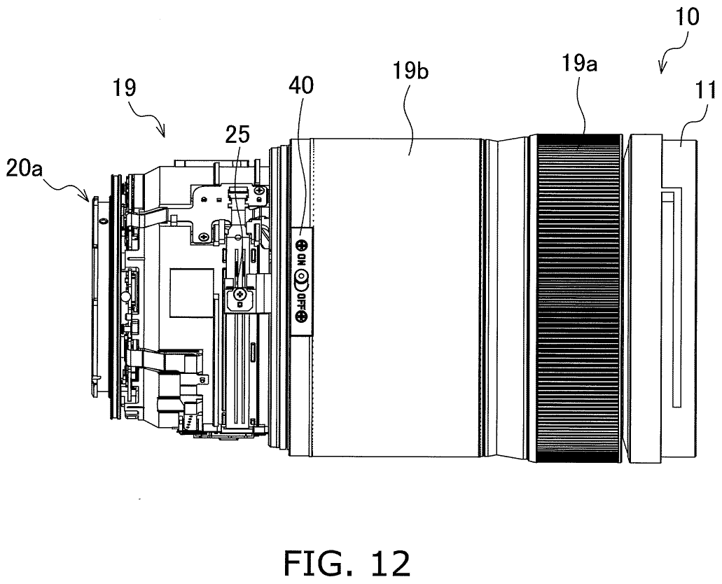

The control board 21 is provided near the end of the lens barrel 10 on the opposite side from the subject side in the optical axis X direction. The control board 21 is connected to a zoom encoder 25 (see FIG. 12, etc.) (discussed below), and controls an actuator (not shown) that changes the relative positions of the lenses L1 to L17 on the basis of the zoom position (magnification position) of the lens group sensed by the zoom encoder 25.

The teleconverter 30 is a generally cylindrical auxiliary member that extends the focal length of the lens barrel 10 to allow for telephoto shooting of 1.4×, for example. As shown in FIGS. 1 and 1B, the teleconverter 30 is mounted to the end (lens mount unit 20a) on the side of the lens barrel 10 that connects to the camera body 50, and encompasses a plurality of lenses L31 to L36 (see FIG. 2B, etc.).

Here, when the teleconverter 30 is mounted to the end of the lens barrel 10 shown in FIG. 2A on the image plane side, which is the opposite side from the subject in the optical axis X direction, the lens group (the lenses L16 and L17) included in the seventh lens group unit 18 and the lens group (L31-L36) included in the teleconverter 30 interfere with each other at the WIDE side position shown in FIG. 2B.

That is, the lenses L16 and L17 included in seventh lens group unit 18 on the lens barrel 10 side are disposed at the end of lens barrel 10 on the opposite side from the subject in the optical axis X direction, at the WIDE side position. On the other hand, the lens group included in teleconverter 30 is disposed so as to protrude toward the side of connection to the lens barrel 10.

Accordingly, when the teleconverter 30 is mounted in a state in which the lens barrel 10 is in the WIDE side position shown in FIG. 2B, the lens group included in the seventh lens group unit 18 (lenses L16 and L17) and the lens group included in the teleconverter 30 (lenses L31-L36) interfere with each other by the amount of interference shown in FIGS. 2A, 2B, etc.

Here, when the teleconverter 30 is mounted to the end of the lens barrel 10 on the opposite side from the subject in the optical axis X direction as shown in FIG. 3A and moves to the TELE side position shown in FIG. 3B, the lens group (lenses L16 and L17) included in the seventh lens group unit 18 and the lens group (L31-L36) included in teleconverter 30 do not interfere with each other.

In view of this, the lens barrel 10 of this embodiment is provided with a retraction mechanism on the seventh lens group unit 18 side to avoid interference between the lenses L16 and L17 and the lenses L31, etc., on the teleconverter 30 side at the WIDE side position.

### (2) Retraction Mechanism of Seventh Lens Group Unit 18

With the lens barrel 10 in this embodiment, in the WIDE side position, a part of the seventh lens group unit 18 (the lenses L16 and L17) interferes with a part of the teleconverter 30 (the lenses L31, etc.), so the retractable lens frame 18b, which holds the lenses L16 and L17, is moved to the subject side in the optical axis X direction to avoid this interference.

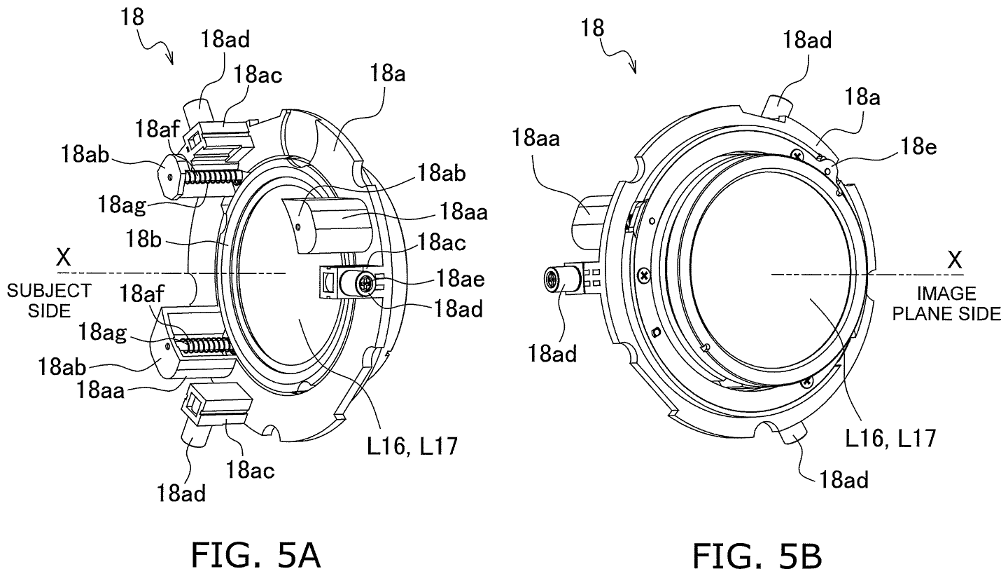

That is, as shown in FIGS. 5A and 5B, the seventh lens group unit 18 has a lens drive frame 18a, a retractable lens frame 18b, a lens presser 18c, a pressing member 18d, and a screw 18e.

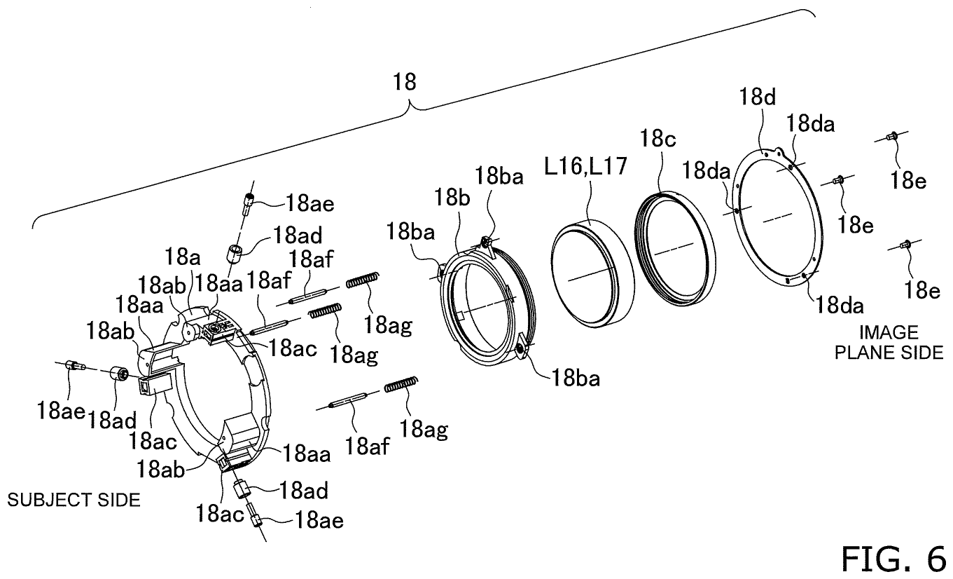

As shown in FIG. 6, the lens drive frame 18a is a substantially annular resin member, and has three housings 18aa, three shaft holders 18ab, three cam pin bases 18ac, three cam pins 18ad, three fixing members 18ae, three guide shafts 18af, and three compression springs 18ag (biasing members) provided on its surface on the subject side in the optical axis X direction. Also, the retractable lens frame 18b is mounted in the opening of the substantially annular lens drive frame 18a in a state of being able to move to the subject side in the optical axis X direction.

As shown in FIG. 5A, the housings 18aa are provided at three locations, protruding from the surface of the lens drive frame 18a on the subject side in the optical axis X direction. The housings 18aa are provided so as to cover the outer peripheries of the guide shafts 18af and the compression springs 18ag.

As shown in FIG. 5A, the shaft holders 18ab are each a plate-like member that covers the end on the subject side of a housing 18aa, and supports the end on the subject side of the guide shaft 18af.

As shown in FIG. 5A, the cam pin bases 18ac are provided in three locations, protruding in the optical axis X direction from positions adjacent to the housings 18aa on the subject-side surface of the lens drive frame 18a. The cam pin bases 18ac hold the cam pins 18ad at their subject-side ends.

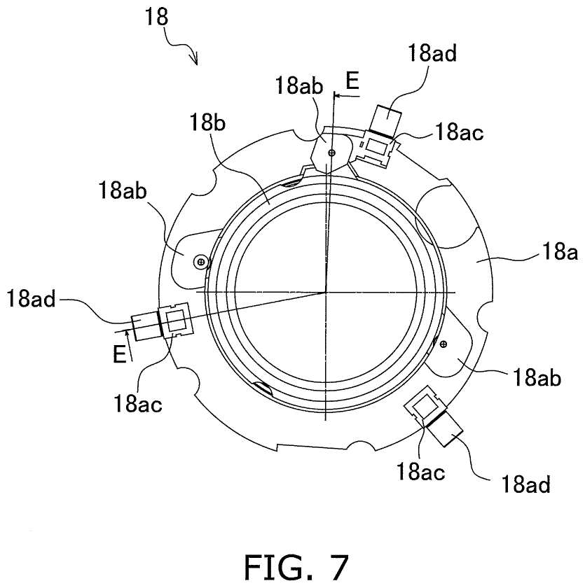

As shown in FIG. 5A, the cam pins 18ad are each a substantially cylindrical member that is provided so as to protrude radially outward from the end of a cam pin base 18ac on the subject side, centered on the optical axis X. As shown in FIG. 6, the cam pins 18ad are fixed to the cam pin bases 18ac from the outside in the radial direction by the fixing members 18ae. Furthermore, as shown in FIG. 7, the three cam pins 18ad are disposed at substantially equal angular intervals (approximately 120-degree intervals) as viewed from the optical axis X direction. The cam pins 18ad are disposed so as to fit into the rectilinear grooves and cam grooves provided in the rectilinear cam barrel 17a and the cam barrel 17b described above, and move along the cam grooves as the cam barrel 17b rotates.

This allows the seventh lens group unit 18 to be moved back and forth in the optical axis X direction.

As shown in FIG. 6, the fixing members 18ae are attached to the inner peripheral side of the substantially cylindrical cam pins 18ad, and fix the cam pins 18ad to the cam pin bases 18ac from the outside in the radial direction centered on the optical axis X.

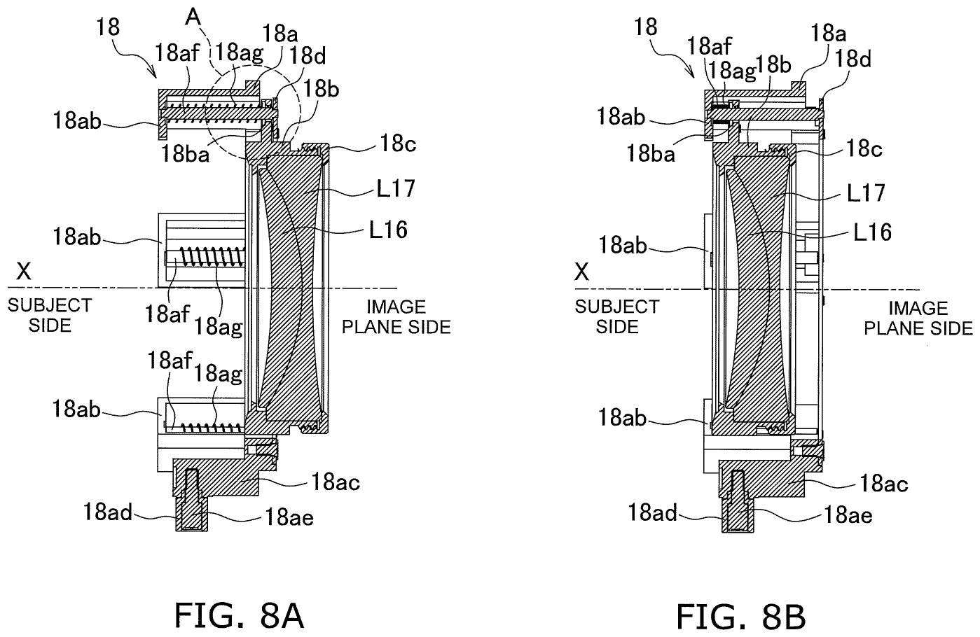

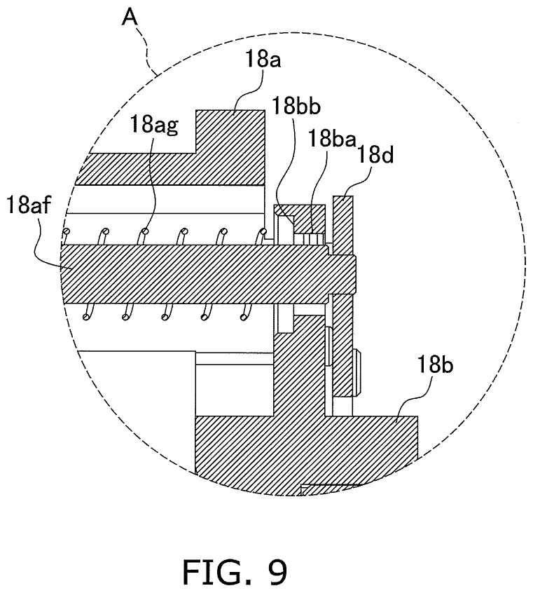

The guide shafts 18af are each a rod-shaped member that guides the movement when the retractable lens frame 18b is retracted to the subject side in the optical axis X direction when teleconverter 30 has been mounted to lens barrel 10, and is disposed within a housing 18aa along the optical axis X as shown in FIGS. 8A and 8B. Also, as shown in FIGS. 8A and 8B, the ends of the guide shafts 18af on the subject side in the optical axis X direction are held by the shaft holders 18ab, and the ends on the image plane side are held by the pressing member 18d as shown in FIG. 9.

As shown in FIGS. 8A and 8B, the compression springs 18ag (biasing members) are attached to the outer periphery of the guide shafts 18af. When the teleconverter 30 has not been mounted, as shown in FIG. 8A, the compression springs 18ag bias the retractable lens frame 18b to the image plane side in the optical axis X direction. When the teleconverter 30 has been mounted (WIDE side position), as shown in FIG. 8B, the compression springs 18ag contract when the retractable lens frame 18b moves to the subject side.

Also, in a state in which the teleconverter 30 has not been mounted, when the cam pins 18ad move along the cam groove due to rotation of the cam barrel 17b, the compression springs 18ag apply a biasing force to the retractable lens frame 18b such that there is no change in the distance between the retractable lens frame 18b holding the lenses L16 and L17 and the cam pins 18ad.

This eliminates the effect of the expansion and contraction of the compression spring 18ag when the cam pins 18ad, etc., are driven along the cam groove to vary the relative positions of the lenses L1 to L17 to a position on the WIDE side or a position on the TELE side.

On the other hand, the compression springs 18ag expand and contract only when the teleconverter 30 has been mounted to the lens barrel 10 near the WIDE position, thereby avoiding interference between the seventh lens group unit 18 and the teleconverter 30 during mounting of the teleconverter 30.

The retractable lens frame 18b is encompassed within the lens drive frame 18a of the seventh lens group unit 18, and holds the lenses L16 and L17 shown in FIG. 6. Also, as shown in FIG. 8A, in a state in which the teleconverter 30 has not been mounted, the retractable lens frame 18b is biased to the image plane side in the optical axis X direction by the compression springs 18ag. As shown in FIG. 8B, when the teleconverter 30 is mounted (WIDE side position), the compression springs 18ag contract and the retractable lens frame 18b moves to the subject side.

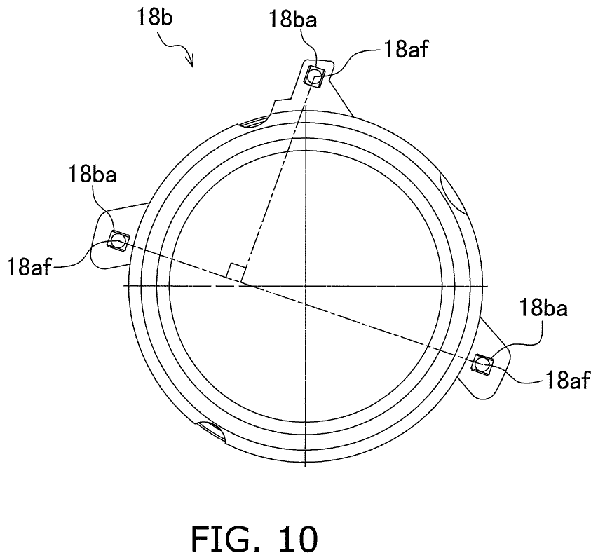

Here, the retractable lens frame 18b has guide shaft holes 18ba (see FIGS. 9 and 10) provided at three locations so as to protrude outward in the radial direction from the substantially cylindrical outer peripheral surface.

Consequently, the retractable lens frame 18b moves back and forth in the optical axis X direction along the three guide shafts 18af inserted into the guide shaft holes 18ba.

As shown in FIG. 9, the guide shaft holes 18ba each have a step portion 18bb at the portion where a guide shaft 18af is inserted, and the contact portion opposite the guide shaft 18af is thin-walled.

Consequently, in a configuration in which the retractable lens frame 18b is guided in the optical axis X direction by the three guide shafts 18af, the retractable lens frame 18b can move smoothly in the optical axis X direction, without catching on anything.

As shown in FIG. 6, the lens presser 18c is attached to the image plane side of the retractable lens frame 18b in the optical axis X direction in order to hold the lenses L16 and L17 on the inner peripheral side of the retractable lens frame 18b. As shown in FIGS. 8A and 8B, the lens presser 18c is fixed to the retractable lens frame 18b by screwing together the threaded grooves formed therein.

As shown in FIG. 6, the pressing member 18d is an annular member, and is fixed to the lens drive frame 18a in a state in which the screw 18e has been inserted into the screw hole 18da from the image plane side in the optical axis X direction. Also, as shown in FIG. 9, the pressing member 18d is pressed against the portion of the retractable lens frame 18b where the guide shaft holes 18ba are provided by the biasing force of the compression springs 18ag, restricting the movement of the retractable lens frame 18b to the image plane side in the optical axis X direction. Furthermore, as shown in FIG. 9, the pressing member 18d holds the ends on the image plane side of the three guide shafts 18af.

Here, as shown in FIG. 10, the three guide shafts 18af that guide the retractable lens frame 18b to move back and forth in the optical axis X direction include two guide shafts 18af that are disposed in approximately opposing positions on the outer peripheral surface of the seventh lens group unit 18, and one guide shaft 18af that is disposed at a position perpendicular to a straight line connecting the two guide shafts 18af.

Consequently, the positional accuracy (orientation) of the retractable lens frame 18b can be kept normal by fitting together with the guide shafts 18af at three locations. Also, the seventh lens group unit 18 can be moved back and forth in the optical axis X direction while avoiding interference with the components inside the lens barrel 10.

As mentioned above, with the lens barrel 10 of this embodiment, when the teleconverter 30 is mounted to the end of lens barrel 10 on the opposite side from the subject side (image plane side) in the optical axis X direction as shown in FIG. 1B, etc., the seventh lens group unit 18 retracts from the position shown in FIG. 8A to the subject side as shown in FIG. 8B to avoid interference with the teleconverter 30.

At this point, the cam pins 18ad included in the seventh lens group unit 18 remain engaged with the cam grooves of the cam barrel 17b, etc., and do not move.

As a result, even when the teleconverter 30 is mounted, as shown in FIGS. 8A and 8B, only the retractable lens frame 18b included in the seventh lens group unit 18 moves to the subject side in the optical axis X direction.

Consequently, during mounting of the teleconverter 30, the retractable lens frame 18b that holds the lenses L16 and L17 is retracted while the position of the lens drive frame 18a that holds the cam pins 18ad remains unchanged, and this eliminates the effect on other lens frames that would otherwise accompany the rotation of the cam barrel 17b, etc.

### (3) Zoom Limit Switch 40

With the lens barrel 10 of this embodiment, when the above-mentioned teleconverter 30 is mounted to the lens barrel 10, the retractable lens frame 18b holding the lenses L16 and L17 included in the seventh lens group unit 18 is retracted to the subject side, and this avoids interference between the teleconverter 30 and the lenses L16 and L17 included in the seventh lens group unit 18.

At this point, in a state in which the teleconverter 30 has been mounted, the positions of the lenses L16 and L17 included in the seventh lens group unit 18 have moved more toward the subject side than when the teleconverter 30 has not been mounted, so the lens positions are irregular, and as a result the zoom range is narrower.

In view of this, the lens barrel 10 of this embodiment is provided with a zoom limit switch (rotation restriction portion) 40 that rotates integrally with the zoom ring unit 19b when the teleconverter 30 is mounted, and restricts the rotation of the zoom ring unit 19b beyond the position where the retractable lens frame 18b comes into contact with the teleconverter 30 when the teleconverter 30 has been mounted to the lens mount unit 20a.

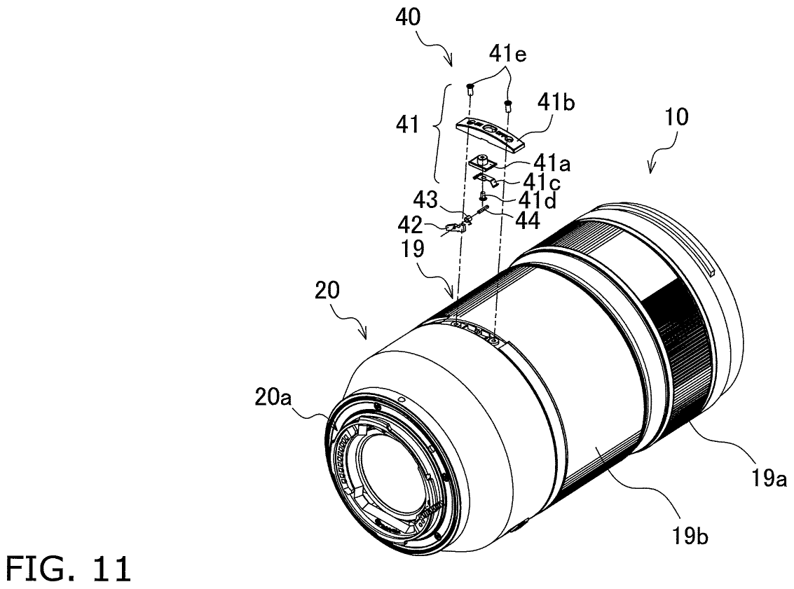

As shown in FIG. 11, the zoom limit switch 40 is attached to the outer peripheral surface of the lens barrel 10, is turned on and off by the user, and rotates integrally with the zoom ring unit 19b.

As shown in FIG. 11, the zoom limit switch 40 has a switch unit 41, a restriction member 42, a coil spring 43, a rotation shaft 44, a bearing portion 45, a convex portion 46a, a concave portion 46b, a metal plate 47 (metal member), sliding surfaces 48a and 48b, and a restriction member housing portion 49.

As shown in FIG. 12, the zoom limit switch 40 is disposed at a position adjacent to the zoom encoder 25 provided on the outer peripheral surface of the ring mount base 19.

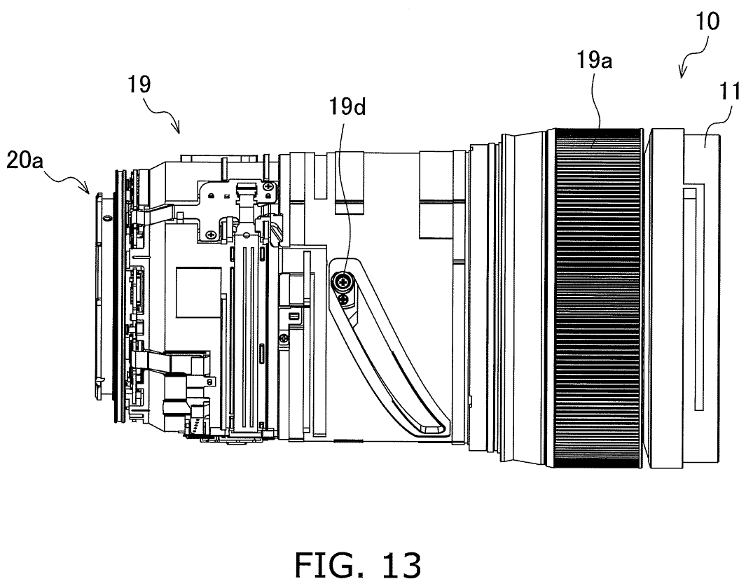

The rotation of the zoom ring 19ba, whose rotation range is restricted by the zoom limit switch 40, is transmitted to a zoom drive pin 19d that protrudes toward the inner peripheral side of the zoom ring unit 19b, as shown in FIG. 13.

The zoom drive pin 19d is fitted into a zoom drive pin fitting hole 19bd provided to the zoom ring 19ba. As a result, the rotational operation of the zoom ring 19ba is transmitted to the zoom drive pin 19d.

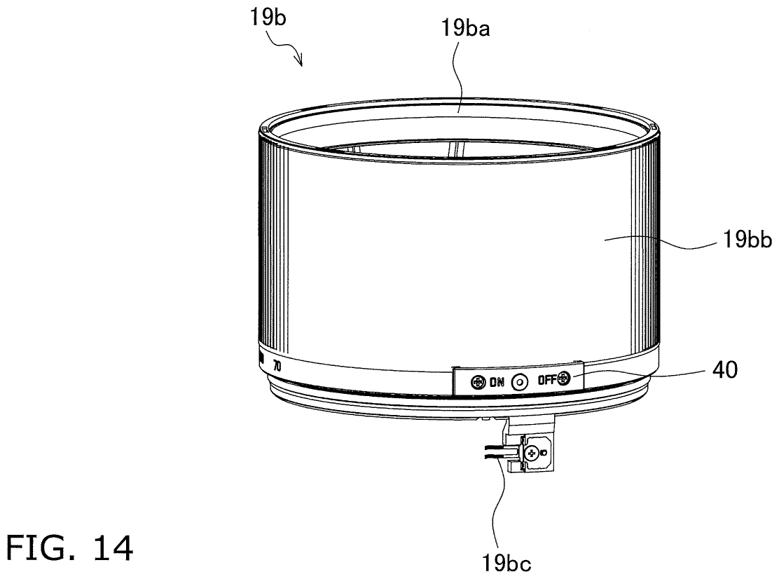

As shown in FIG. 14, the zoom ring unit 19b has a zoom ring rubber 19bb wound around its cylindrical outer peripheral surface, and is rotated by the user. The zoom limit switch 40 is disposed at a position adjacent to the zoom ring rubber 19bb. The zoom ring unit 19b also has a zoom encoder brush 19bc provided so as to protrude in the optical axis direction from the position where the zoom limit switch 40 is disposed.

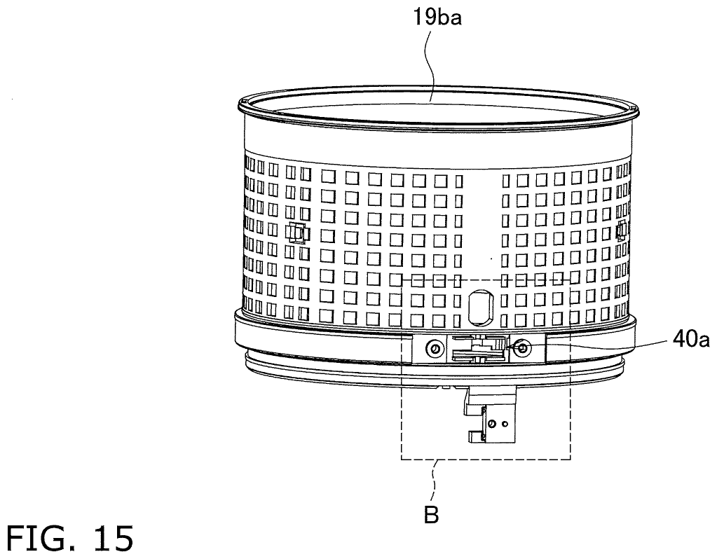

As shown in FIG. 15, the switch unit 41 is installed on a switch installation portion 40a provided to the outer peripheral surface of the ring mount base 19 (zoom ring unit 19b).

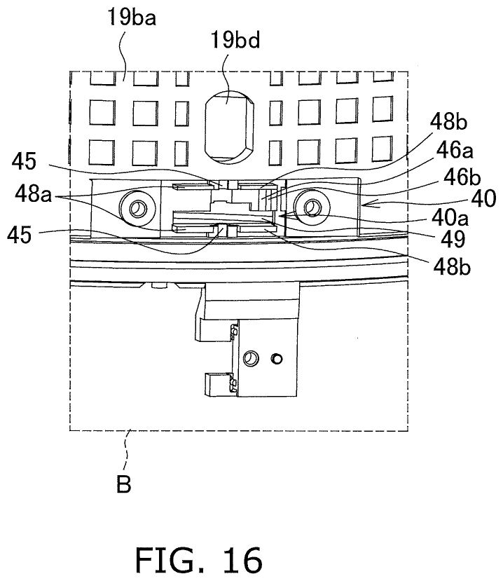

The switch installation portion 40a is molded integrally with the resin zoom ring 19ba, and has a bearing portion 45, a convex portion 46a, a concave portion 46b, sliding surfaces 48a and 48b, and a restriction member housing portion 49, as shown in FIG. 16.

The switch unit 41 is the portion used by the user to input operations to the zoom ring unit 19b, and as shown in FIG. 11, has an operation portion 41a, a cover 41b, a leaf spring 41c (elastic member), fixing screws 41d and 41e, and a contact portion 41f.

The operation portion 41a is disposed so as to protrude from the outer peripheral surface of the zoom ring unit 19b, and switches the zoom limit switch 40 on and off by moving back and forth in the peripheral direction.

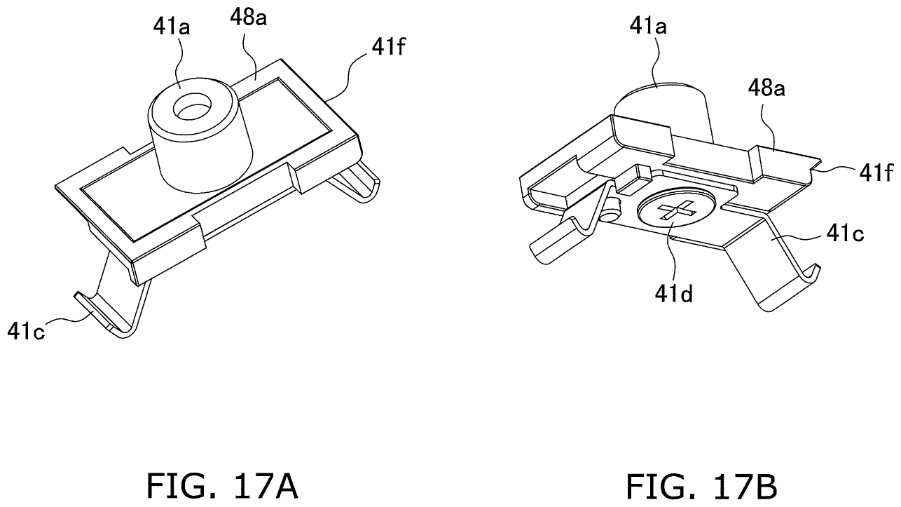

The operation portion 41a slides in the left-right direction in the drawing on the sliding surfaces 48a and 48b included in the switch installation portion 40a shown in FIG. 16, thereby switching the zoom limit switch 40 on or off. As shown in FIG. 17A, the operation portion 41a has a substantially flat part and a cylindrical part protruding from the substantially flat upper surface. As shown in FIG. 17B, the cylindrical part of the operation portion 41a is fixed to the back side of the flat part together with a leaf spring 41c by using a fixing screw 41d.

The cover 41b is a member that covers the periphery of the cylindrical portion of the operation portion 41a, and is fixed to the outer peripheral surface of the ring mount base 19 by using fixing screws 41e. The operation portion 41a is used in a state of protruding from the elliptical opening of the cover 41b.

The leaf spring 41c (elastic member) is provided below the operation portion 41a and biases the operation portion 41a toward the inner surface of the cover 41b.

The contact portion 41f is provided at the end of the flat part of the operation portion 41a, and hits a part of the restriction member 42 to rotate the restriction member 42. Consequently, the zoom limit switch 40 can be switched on and off by changing the rotational position of the restriction member 42.

The restriction member 42 is a metal member, and is disposed in the restriction member housing portion 49 provided to the switch installation portion 40a shown in FIG. 16, in a state of being able to rotate around the rotation shaft 44. The restriction member 42 rotates around the rotation shaft 44 in conjunction with the on/off switching operation of the operation portion 41a.

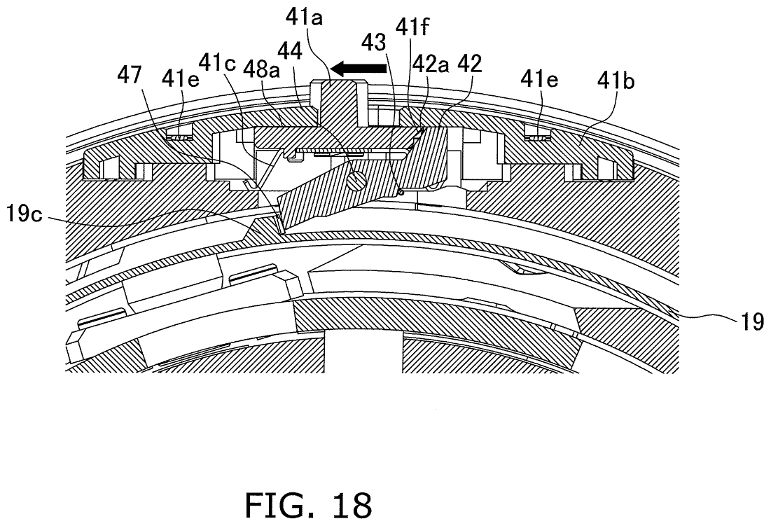

The coil spring 43 applies a biasing force to the restriction member 42 in the rotation direction (counterclockwise in FIG. 18).

The rotation shaft 44 is the rotational center of the restriction member 42, and both ends thereof are supported by bearing portions 45 provided to the switch installation portion 40a shown in FIG. 16.

The bearing portions 45 are recesses formed in the switch installation portion 40a provided on the zoom ring 19ba side, and support the ends of the rotation shaft 44.

The convex portion 46a is provided to maintain the position of one leg of the leaf spring 41c fixed to the lower side of the operation portion 41a when the zoom limit switch 40 is in its ON state, and to generate a clicking sensation when the zoom limit switch 40 is switched on or off.

When the zoom limit switch 40 is in its OFF state, the concave portion 46b mates with and holds one leg of the leaf spring 41c fixed to the lower side of the operation portion 41a, which maintains the OFF state of the zoom limit switch 40.

As shown in FIG. 18, the metal plate 47 (metal member) is a flat metal member provided at a position where the left end of the restriction member 42 and a contact portion 19c on the ring mount base 19 come into contact with each other, and is attached on the contact portion 19c side.

Consequently, even when the metal restriction member 42 and the contact portion 19c repeatedly come into contact and separate from each other, positioning the metal plate 47 at the contact position prevents the resin contact portion 19c from wearing out or being damaged.

Here, when the operation portion 41a is in the ON position, the restriction member 42 is biased counterclockwise by the coil spring 43 as shown in FIG. 18, and its left end is in contact with the contact portion 19c provided on the ring mount base 19 side.

As a result, when the zoom limit switch 40 is in its ON state, the restriction member 42 restricts the rotational operation of the zoom ring unit 19b relative to the ring mount base 19, as shown in FIG. 18.

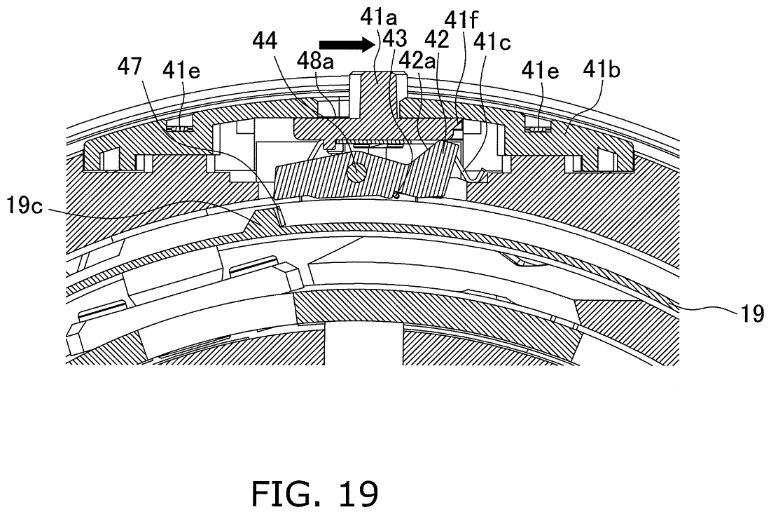

On the other hand, when the operation portion 41a is in its OFF position, the operation portion 41a moves in the direction of the arrow shown in FIG. 19, causing the restriction member 42 to rotate against the biasing force of the coil spring 43. At this point, the contact portion 41f on the operation portion 41a side pushes in on the contact portion 42a on the restriction member 42 side, causing the restriction member 42 to rotate clockwise.

Consequently, when the zoom limit switch 40 is in its OFF state, the restriction on the rotational operation of the zoom ring unit 19b relative to the ring mount base 19 is released by the restriction member 42, as shown in FIG. 19.

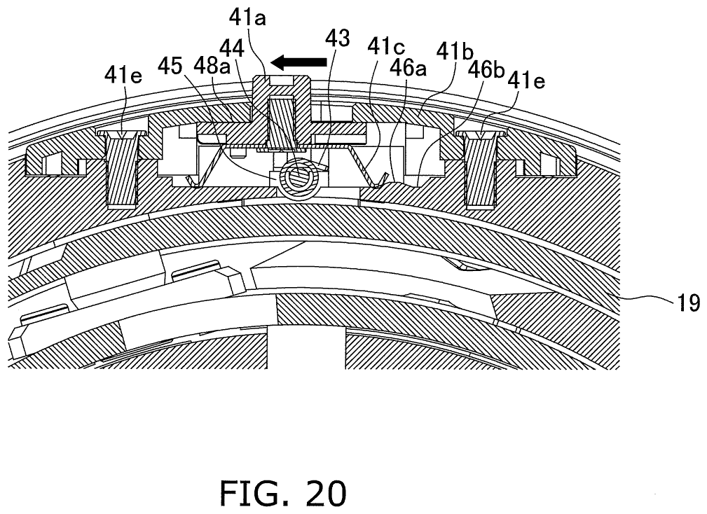

When the zoom limit switch 40 is in its ON position, as shown in FIG. 20, of the two legs of the leaf spring 41c fixed to the lower side of the operation portion 41a, the leg on the right side in the drawing is disposed adjacent to the left side of the convex portion 46a provided to the switch installation portion 40a.

As a result, the operation portion 41a is restricted from moving to the right in the drawing, and the zoom limit switch 40 is kept in its ON state.

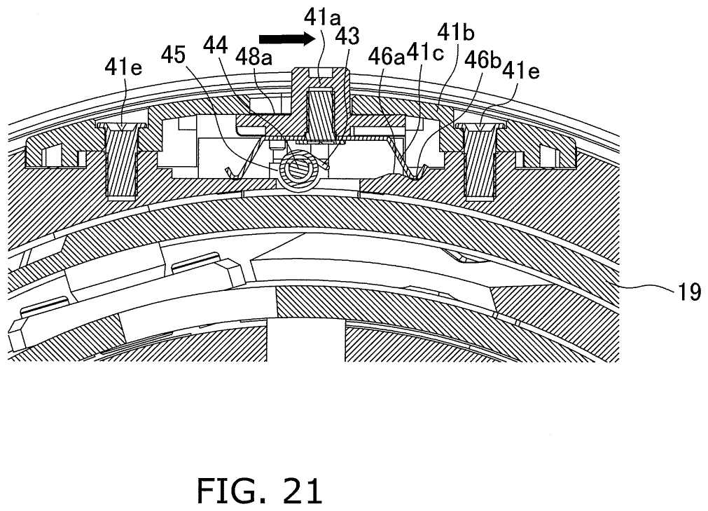

On the other hand, when the zoom limit switch 40 is in its OFF position, as shown in FIG. 21, of the two legs of the leaf spring 41c fixed to the lower side of the operation portion 41a, the leg on the right side in the drawing rides up and over the convex portion 46a provided to the switch installation portion 40a and is held in the concave portion 46b.

This restricts the movement of the operation portion 41a to the left in the drawing, produces a clicking sensation when the right leg of the leaf spring 41c rides up over the convex portion 46a, and maintains the zoom limit switch 40 in its OFF state.

(4) Display Control when Teleconverter 30 is Mounted

With the lens barrel 10 of this embodiment, when the teleconverter 30 is mounted, the lenses L16 and L17 of the seventh lens group unit 18 are not in their normal positions but in a retracted position, and therefore the control board 21 (see FIG. 24) is provided to perform display control to encourage the user to be careful when photographing.

As shown in FIG. 24, the control board 21 is connected to a zoom encoder 25, and senses whether the positions of the lenses L1 to L17 are on the wide angle side or the telephoto side on the basis of the output from the zoom encoder 25.

As shown in FIG. 12, the zoom encoder 25 is disposed on the inner peripheral side of the zoom ring unit 19b, and senses the relative positions of the lenses L1 to L17 included in the lens barrel.

As shown in FIG. 13, the rotation of the zoom ring unit 19b is transmitted to the zoom drive pin 19d, which is provided so as to protrude toward the inner peripheral side of the zoom ring unit 19b.

The zoom drive pin 19d is fixed with screws to the above-mentioned cam barrel 17b, and when the zoom ring unit 19b is manually rotated, the cam barrel 17b rotates via the zoom drive pin 19d, which changes the relative positions of the lenses L1 to L17 included in the lens barrel 10.

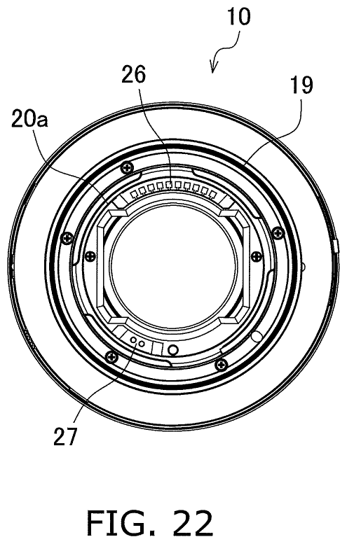

As shown in FIG. 22, the control board 21 is electrically connected to the teleconverter 30 or the camera body 50 via electrical contacts (mount contact 26 and teleconverter identification terminal 27) provided at the end of the lens barrel 10 on the opposite side from the optical axis X direction.

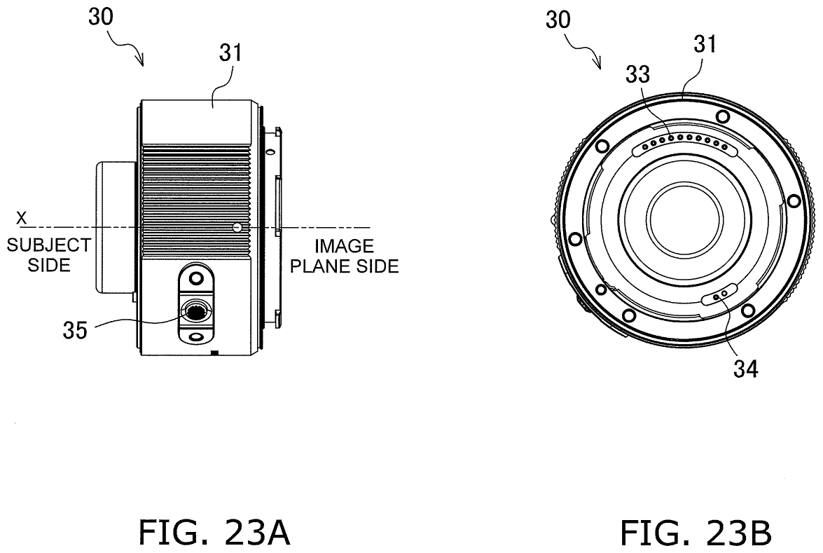

Similarly, as shown in FIGS. 23A and 23B, the teleconverter 30 is equipped with a main body 31, a mount contact 32 provided on the surface of the main body 31 that connects to the camera body 50, a lens contact pin 33 (see FIG. 24) provided on the surface of the main body 31 that connects to the lens barrel 10, a teleconverter identification terminal 34, and a removal button 35 that is pushed when removing the teleconverter 30 from the lens barrel 10.

The mount contact 32 is disposed so that when the teleconverter 30 is mounted to the camera body 50, there is contact with a contact pin 53 (see FIG. 24) provided on the camera body 50 side. This allows the camera body 50 to send and receive various kinds of signal to and from the teleconverter 30 via the mount contact 32.

The lens contact pin 33 (see FIG. 24) is disposed on the side connected to the lens barrel 10. When the teleconverter 30 is mounted to the lens barrel 10, the lens contact pin 33 is electrically connected to the mount contact 26 on the lens barrel 10 side. Also, as shown in FIG. 24, the lens contact pin 33 is electrically connected to the mount contact 32 inside the teleconverter 30.

Similar to the lens contact pin 33, the teleconverter identification terminal 34 is disposed on the side connected to the lens barrel 10, as shown in FIG. 23B. When the teleconverter 30 is mounted to the lens barrel 10, the teleconverter identification terminal 34 is electrically connected to the teleconverter identification terminal 27 on the lens barrel 10 side. Also, the teleconverter identification terminal 34 is electrically connected to the mount contact 32 inside the teleconverter 30, as shown in FIG. 24.

With the lens barrel 10 in this embodiment, in a state in which the teleconverter 30 has been mounted between the camera body 50 and the lens barrel 10, the control board 21 detects the connection between the teleconverter identification terminal 27 and the teleconverter identification terminal 34, and sends a signal to the camera body 50 indicating that the teleconverter 30 has been mounted.

On the other hand, when the teleconverter 30 is not mounted between the camera body 50 and the lens barrel 10, the control board 21 cannot detect any connection between the teleconverter identification terminal 27 and the teleconverter identification terminal 34, and therefore does not transmit a signal indicating that the teleconverter 30 has been mounted to the camera body 50.

This allows the camera body 50 to determine whether or not the teleconverter 30 has been mounted on the basis of whether or not a signal has been received from the control board 21 of the lens barrel 10.

Also, with the lens barrel 10 in this embodiment, when the teleconverter 30 is mounted between the camera body 50 and the lens barrel 10 as shown in FIG. 24, as mentioned above, the positions of the lenses L16 and L17 included in the seventh lens group unit 18 may move due to the expansion and contraction of the compression springs 18ag, and may be retracted to a position that is not the proper position.

Consequently, when the teleconverter 30 has been mounted, the control board 21 receives a signal indicating the relative positions of the lenses L1 to L17 included in the lens barrel 10 sensed by the zoom encoder 25 (such as the position on the wide angle side, the position on the telephoto side), and transmits a display control signal to cause the display panel 52 of the camera body 50 to display a message recommending use on the telephoto side.

As a result, the control board 51 of the camera body 50, which has received a display control signal from the control board 21 of the lens barrel 10 via the mount contact 26, the lens contact pin 33, the mount contact 32, and the contact pin 53, can control the display panel 52 to display a message recommending that the user use the camera on the telephoto side.

Therefore, by looking at the notification message displayed on the display panel 52 of the camera body 50, the user can recognize that proper photography cannot be performed in the wide angle position because the lens position is not what it should be.

As a result, in a state in which the teleconverter 30 is mounted, the conditions for proper photography can be displayed on the display panel 52 on the camera body 50 side while avoiding interference between the parts of the lens barrel 10 and the teleconverter 30.

### Main Features

The lens barrel 10 of this embodiment is a lens barrel that is interchangeably mounted to the camera body 50, and includes the lens mount unit 20a, the retractable lens frame 18b, the seventh lens group unit 18, the three cam pins 18ad, the guide shafts 18af, the pressing member 18d, and the compression springs 18ag. The teleconverter 30 is mounted to the lens mount unit 20a. The retractable lens frame 18b includes optical lenses that interfere in the optical axis X direction when the teleconverter 30 is mounted. The seventh lens group unit 18 encompasses the retractable lens frame 18b. The three cam pins 18ad are provided to the seventh lens group unit 18 and protrude in a direction intersecting the optical axis X direction. At least two of the guide shafts 18af are provided to the seventh lens group unit 18 and are disposed along the optical axis X direction. The pressing member 18d is attached to the image plane side of the seventh lens group unit 18 and restricts movement of the retractable lens frame 18b to the image plane side in the optical axis X direction. The compression springs 18ag are attached along the guide shafts 18af and apply a biasing force that biases the retractable lens frame 18b against the pressing member 18d in the optical axis X direction, and expand and contract when the teleconverter 30 is mounted to the lens mount unit 20a, to retract the retractable lens frame 18b to the subject side in the optical axis X direction.

Consequently, when the teleconverter 30 is mounted to the opposite side (image plane side) of the lens barrel 10 from the subject side in the optical axis direction, the retractable lens frame 18b holding the lenses L16 and L17 included in the seventh lens group unit 18 disposed closest to the image plane side of the lens barrel 10 comes into contact with the lens L31, etc., included in the teleconverter 30 and is pressed in the optical axis X direction. At this point, the compression springs 18ag contract, causing the retractable lens frame 18b to move relative to the cam pins 18ad.

That is, when the teleconverter 30 is mounted to the lens barrel 10, only the retractable lens frame 18b holding the lenses L16 and L17 of the seventh lens group unit 18 moves in the optical axis X direction, and the cam pins 18ad are held without moving in the optical axis X direction.

As a result, in the lens barrel 10 equipped with the seventh lens group unit 18 that is driven in the optical axis X direction by the three cam pins 18ad, damage to parts and other such problems can be avoided when the teleconverter 30 is mounted.

### Embodiment 2

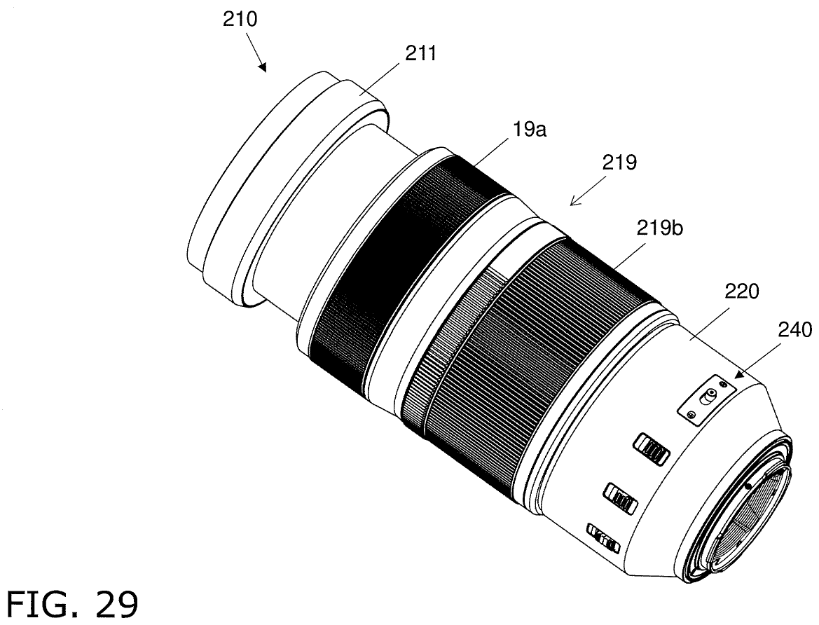

The lens barrel 210 according to another embodiment of the present disclosure will now be described with reference to FIGS. 29 to 35B.

### (1) Configuration of Lens Barrel 210

As shown in FIG. 29, the lens barrel 210 of this embodiment differs from Embodiment 1 above in that a zoom limit switch (rotation restriction portion) 240 is attached to a ring mount base 219 disposed on the inner peripheral surface side of a rear frame unit 220, whereas in Embodiment 1 the zoom limit switch 40 is attached to the zoom ring unit 19b and rotates together with the zoom ring unit 19b.

Those components having the same function as in Embodiment 1 above are numbered the same, and shall not be described again in detail.

That is, the lens barrel 210 of this embodiment is provided with a zoom limit switch (rotation control unit) 240 that restricts the rotational operation of the zoom ring unit 219b beyond the position where the retractable lens frame 18b makes contact with the teleconverter 30 in a state in which the teleconverter 30 has been mounted.

The zoom limit switch 240 is attached to the outer peripheral surface of the lens barrel 210 as shown in FIG. 29, is turned on and off by the user, and is provided on the outer peripheral surface of the ring mount base 219.

As shown in FIG. 29, the lens barrel 210 includes a first lens group unit 211, a ring mount base (fixed frame, base member) 219, a rear frame unit 220, and a zoom limit switch (rotation restriction portion) 240.

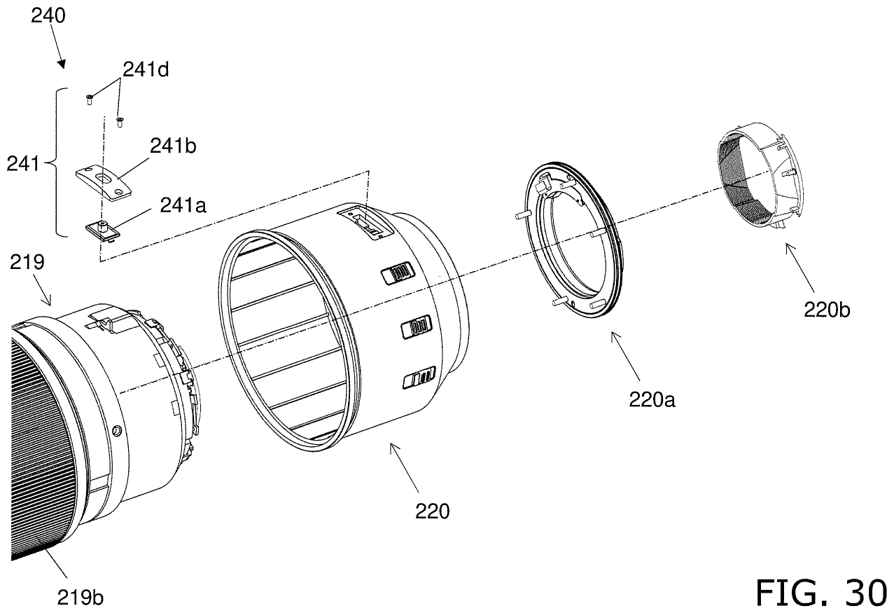

As shown in FIG. 30, the substantially cylindrical rear frame unit 220 is mounted to the outer peripheral surface of the ring mount base 219 on the side where the camera body 50 is mounted, and the zoom limit switch (rotation restriction portion) 240 is also mounted. A lens mount unit 220a and a light shielding frame 220b are attached to the rear end portion of the ring mount base 219.

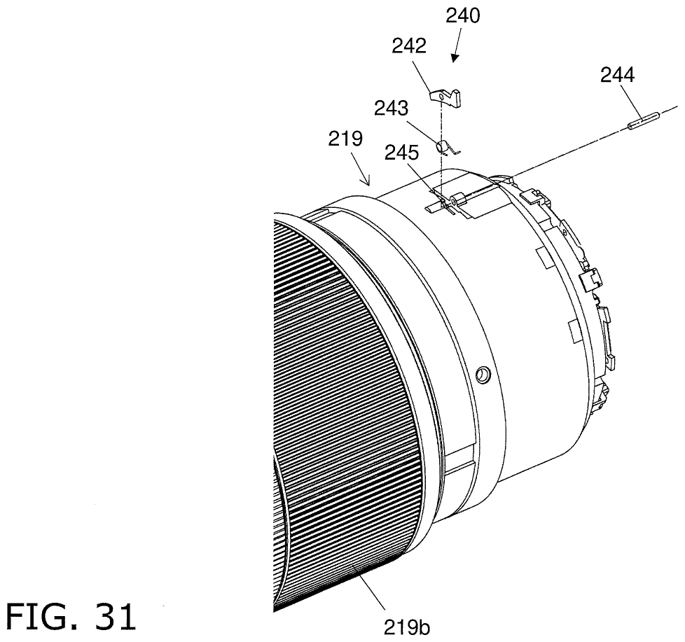

As shown in FIGS. 30 and 31, the zoom limit switch 240 has a switch unit 241, a restriction member 242, a coil spring 243, a rotating shaft 244, and a bearing portion 245.

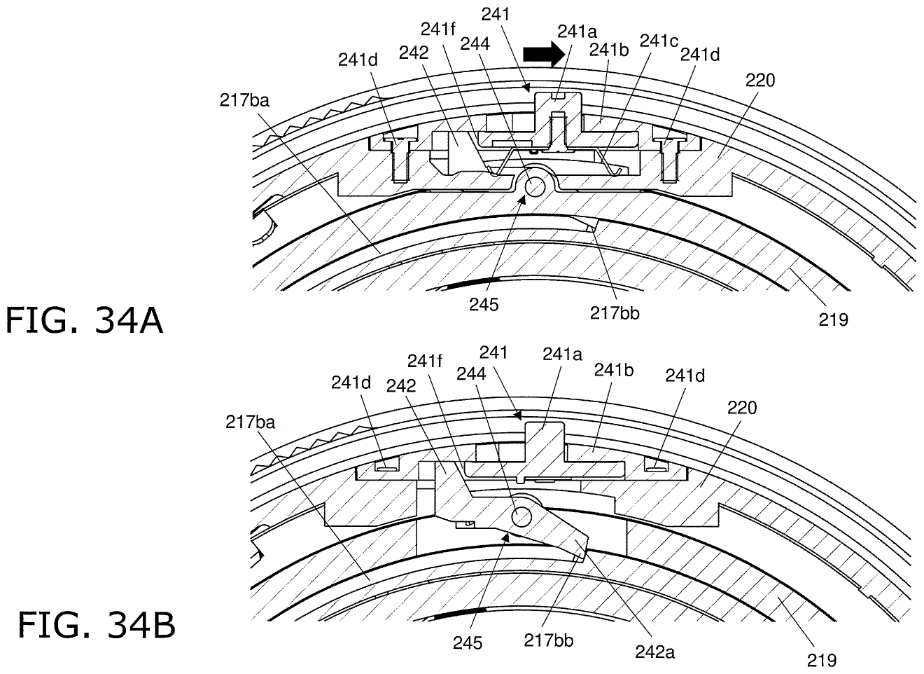

As shown in FIG. 30, the switch unit 241 is provided on the outer peripheral surface of the ring mount base 219. As shown in FIG. 30, the switch unit 241 has an operation portion 241a, a cover 241b, a leaf spring 241c (elastic member) (see FIG. 34A, etc.), fixing screws 241d, and a contact portion 241f.

The operation portion 241a is disposed so as to protrude from the outer peripheral surface of the rear frame unit 220, and switches the zoom limit switch 240 on and off by moving back and forth in the peripheral direction.

As shown in FIG. 34A, etc., the operation portion 241a has a substantially flat portion and a cylindrical portion protruding from the upper surface of the substantially flat portion. The cylindrical portion of the operation portion 241a is fixed with screws to the rear surface of the flat portion along with the leaf spring 241c.

The cover 241b is a member that covers the periphery of the columnar portion of the operation portion 241a, and is fixed with the screws 241d to the outer peripheral surface of the rear frame unit 220. The operation portion 241a is used in a state of protruding from the elliptical opening of the cover 241b.

As shown in FIG. 34A, etc., the leaf spring (elastic member) 241c is provided under the operation portion 241a and biases the operation portion 241a toward the inner surface of the cover 241b.

The contact portion 241f is provided at an end of the flat part of the operation portion 241a, and makes contact with a part of the restriction member 242 to rotate the restriction member 242. This allows the zoom limit switch 240 to be switched on and off by changing the rotational position of the restriction member 242.

The restriction member 242 is a metal member, and as shown in FIG. 31, is disposed on the outer peripheral surface of the ring mount base 219 in a state of being able to rotate around the rotating shaft 244. The restriction member 242 rotates around the rotating shaft 244 in conjunction with the on/off switching operation of the operation portion 241a.

The coil spring 243 applies a biasing force that biases the restriction member 242 in the rotation direction.

The rotating shaft 244 is the center of rotation of the restriction member 242, and is press-fitted into the holes in bearing portions 245 provided on the outer peripheral surface of the ring mount base 219, with both ends thereof supported.

The bearing portions 245 are convex portions formed facing outward in the radial direction from the outer peripheral surface of the ring mount base 219, and support the ends of the rotating shaft 244 in holes formed along the optical axis.

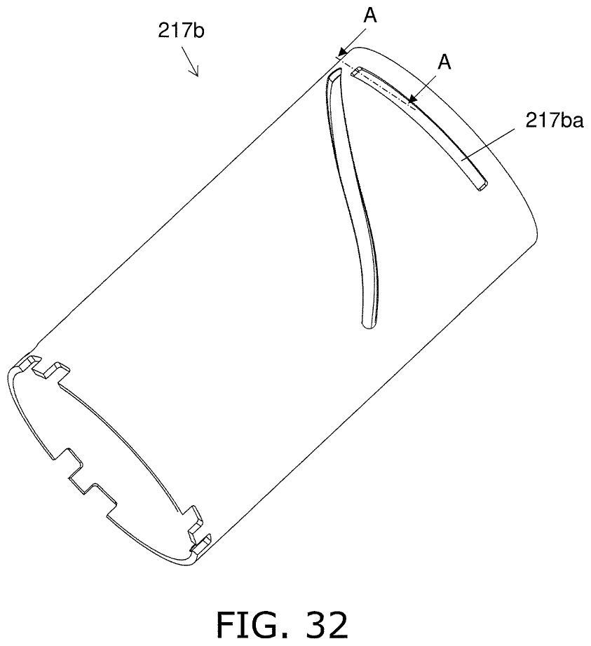

Here, the restriction member 242, which rotates around the rotating shaft 244 on the outer peripheral surface of the ring mount base 219, has one end which moves relatively within a groove 217ba formed in the outer peripheral surface of a cam barrel (rotating member) 217b (see FIG. 32) disposed on the inner peripheral surface side of the ring mount base 219.

That is, when the zoom ring unit 219b is turned, the cam barrel 217b shown in FIG. 32 rotates around the optical axis. At this point, the restriction member 242 provided on the outer peripheral surface of the ring mount base 219 moves along the groove 217ba of the cam barrel 217b.

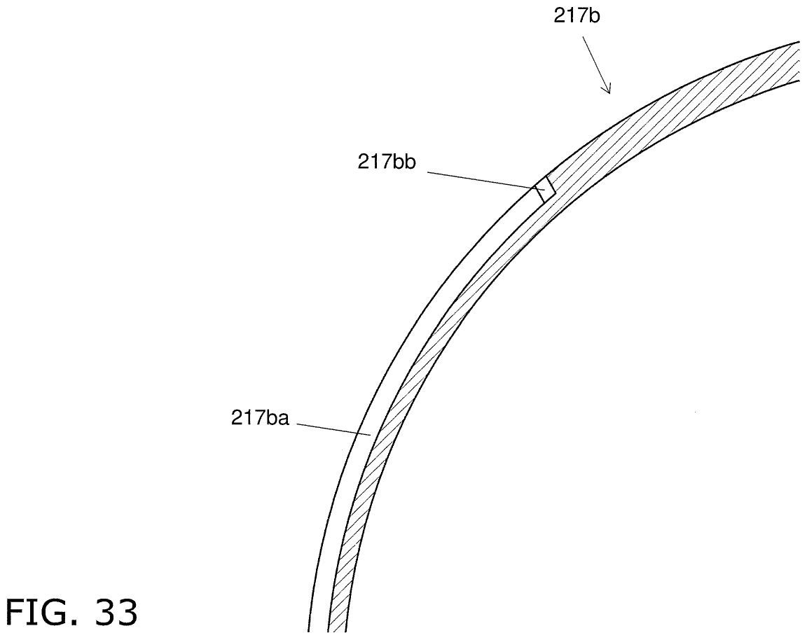

The groove 217ba of the cam barrel 217b makes contact with the restriction member 242 at contact portion 217bb shown in FIG. 33.

This restricts the rotational operation of the zoom ring unit 219b beyond the position where the retractable lens frame 18b comes into contact with the teleconverter 30 in a state in which the teleconverter 30 has been mounted to the lens mount unit 220a.

Here, when the operation portion 241a is in its ON position, the restriction member 242 is biased counterclockwise by the coil spring 243, and as shown in FIGS. 34A and 34B, in this state the end portion on the right side in the drawing (contact portion 242a) is in contact with the contact portion 217bb provided at the end of the groove 217ba of the cam barrel 217b disposed on the inner peripheral surface side of the ring mount base 219.

Consequently, when the operation portion 241a of the zoom limit switch 240 is in its ON state, as shown in FIG. 34B, the rotation of the cam barrel 217b is restricted by the restriction member 242, and this restricts the rotational operation of the zoom ring unit 219b.

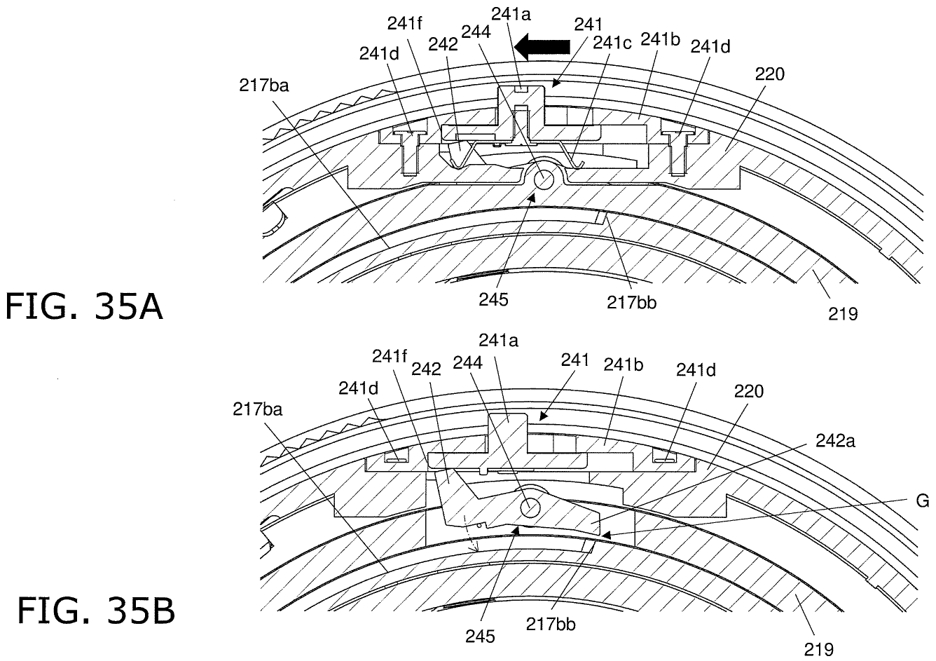

On the other hand, when the operation portion 241a is in its OFF position, the operation portion 241a moves in the direction of the arrow shown in FIG. 35A, so that the restriction member 242 rotates against the biasing force of the coil spring 243. At this point, the contact portion 241f on the operation portion 241a side pushes in on the restriction member 242, causing the restriction member 242 to rotate counterclockwise as shown in FIG. 35B.

At this point, the contact portion 242a of the restriction member 242 is pulled upward from the groove 217ba formed in the outer peripheral surface of the cam barrel 217b, forming a gap G between the contact portion 242a and the outer peripheral surface of the cam barrel 217b, as shown in FIG. 35B.

Consequently, when the operation portion 241a of the zoom limit switch 240 is in its OFF state, the restriction on rotation of the cam barrel 217b by the restriction member 242 is released, as shown in FIG. 35B, and the zoom ring unit 219b can again rotate.

### Embodiment 3

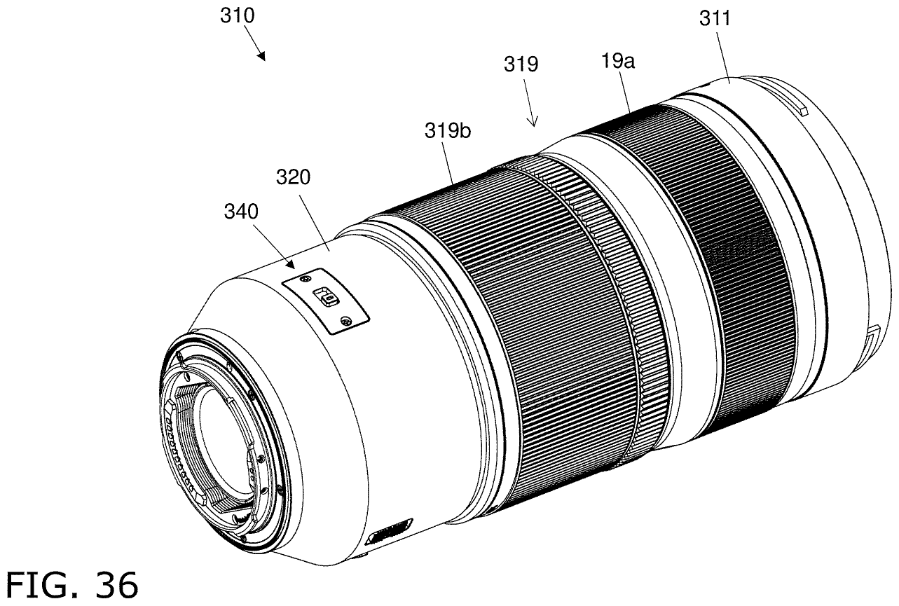

A lens barrel 310 according to yet another embodiment of the present disclosure will now be described with reference to FIGS. 36 to 42B.

### (1) Configuration of Lens Barrel 310

As shown in FIG. 36, the lens barrel 310 of this embodiment differs from Embodiment 1 above in that a unitized zoom limit switch (rotation restriction portion) 340 is attached to the outer peripheral surface of a rear frame unit 320, whereas in Embodiment 1 the zoom limit switch 40 is attached to the zoom ring unit 19b and rotates along with the zoom ring unit 19b.

Those components having the same function as in Embodiment 1 above are numbered the same, and shall not be described again in detail.

Specifically, the lens barrel 310 of this embodiment is provided with a zoom limit switch (rotation restriction unit) 340 that restricts the rotational operation of a zoom ring unit 319b beyond the position where the retractable lens frame 18b makes contact with the teleconverter 30 in a state in which the teleconverter 30 has been mounted.

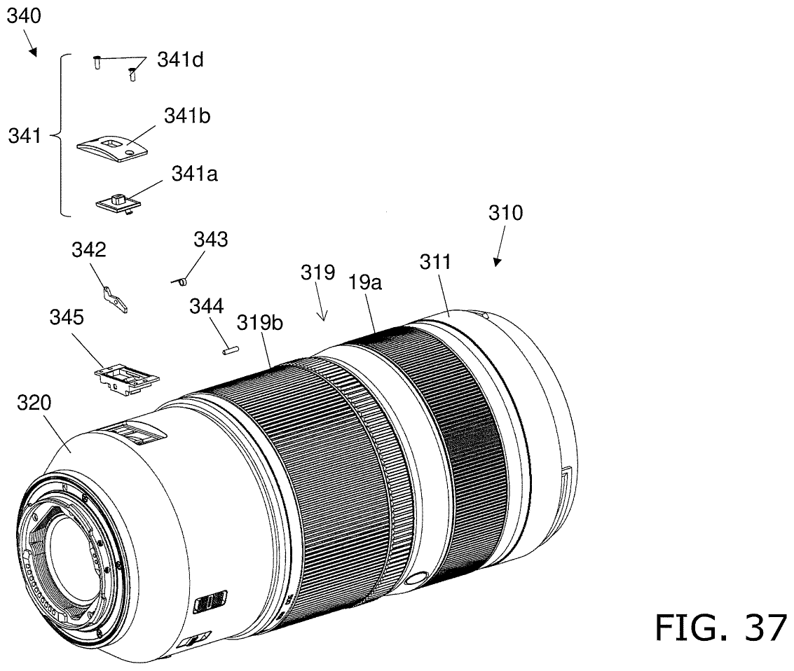

As shown in FIG. 37, the zoom limit switch 340 is attached to the outer peripheral surface of the lens barrel 310, is turned on and off by the user, and is provided on the outer peripheral surface of a rear frame unit 320.

As shown in FIGS. 36 and 37, the lens barrel 310 includes a first lens group unit 311, a ring mount base (fixed frame, base member) 319, a rear frame unit 320, and a zoom limit switch (rotation restriction portion) 340.

As shown in FIG. 37, the zoom limit switch (rotation restriction portion) 340 is attached to the outer peripheral surface of the rear frame unit 320.

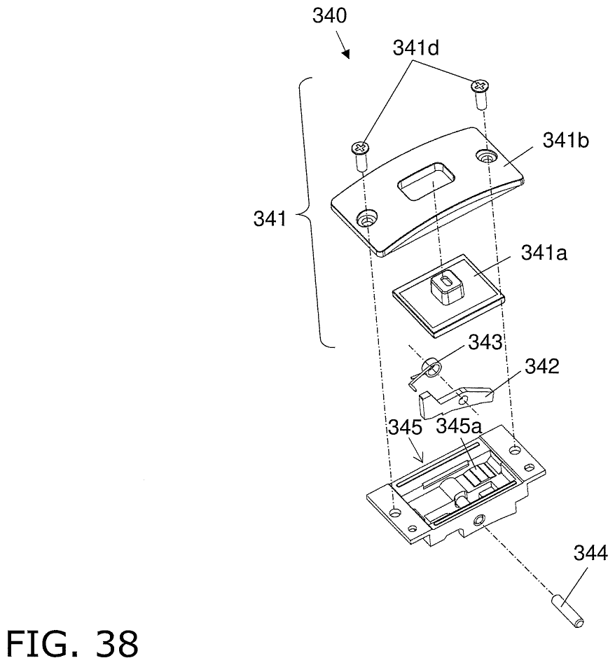

As shown in FIGS. 37 and 38, the zoom limit switch 340 has a switch unit 341, a restriction member 342, a coil spring 343, a rotating shaft 344, and a switch base (base member) 345.

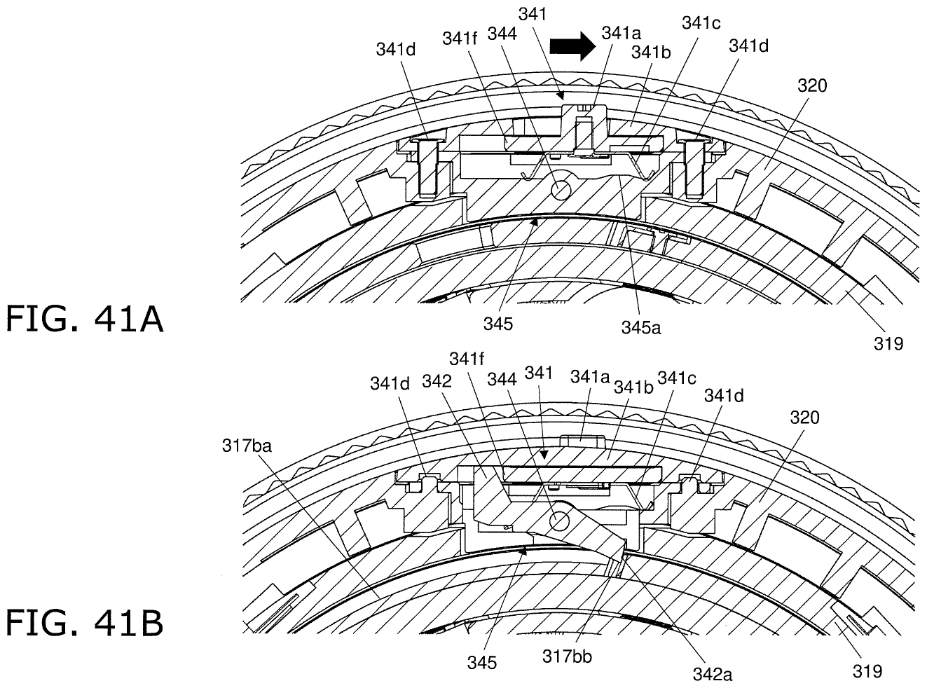

As shown in FIGS. 36 and 37, the switch unit 341 is provided on the outer peripheral surface of the rear frame unit 320. As shown in FIG. 38, the switch unit 341 has an operation portion 341a, a cover 341b, a leaf spring 341c (elastic member) (see FIG. 41A, etc.), fixing screws 341d, and a contact portion 341f (see FIG. 41A).

The operation portion 341a is disposed so as to protrude from the outer peripheral surface of the rear frame unit 320, and moves back and forth in the peripheral direction to switch the zoom limit switch 340 on and off.

As shown in FIG. 38, etc., the operation portion 341a has a substantially flat portion and a columnar portion protruding from the upper surface of the substantially flat portion. The columnar portion of the operation portion 341a is fixed to the rear surface side of the flat portion along with the leaf spring 341c.

The cover 341b is a member that covers the periphery of the columnar portion of the operation portion 341a, and is fixed with the screws 341d to the outer peripheral surface of the rear frame unit 320 together with the switch base 345. The operation portion 341a is used in a state of protruding from a substantially rectangular opening in the cover 341b.

As shown in FIG. 41A, etc., the leaf spring (elastic member) 341c is provided under the operation portion 341a and biases the operation portion 341a toward the inner surface of the cover 341b.

The contact portion 341f is provided at an end of the flat part of the operation portion 341a, and makes contact with part of the restriction member 342 to rotate the restriction member 342. This allows the zoom limit switch 340 to be switched on and off by changing the rotational position of the restriction member 342.

The restriction member 342 is a metal member, and as shown in FIG. 37, is disposed on the outer peripheral surface of the rear frame unit 320 in a state of being able to rotate around the rotating shaft 344. The restriction member 342 rotates around the rotating shaft 344 in conjunction with the on/off switching operation of the operation portion 341a.

The coil spring 343 applies a biasing force that biases the restriction member 342 in the rotation direction.

The rotating shaft 344 is the center of rotation of the restriction member 342, and is press-fitted into a hole provided in the switch base 345, with both ends thereof supported.

The switch base 345 is a case member that allows the zoom limit switch 340 to be removably attached to the outer peripheral surface of the rear frame unit 320, and supports the ends of the rotating shaft 344 in holes formed along the optical axis.

Consequently, all of the components that make up the zoom limit switch 340 are disposed within the switch base 345, so if a problem should occur with the zoom limit switch 340, there will be no need to disassemble the rear frame unit 320. This facilitates maintenance of the zoom limit switch 340.

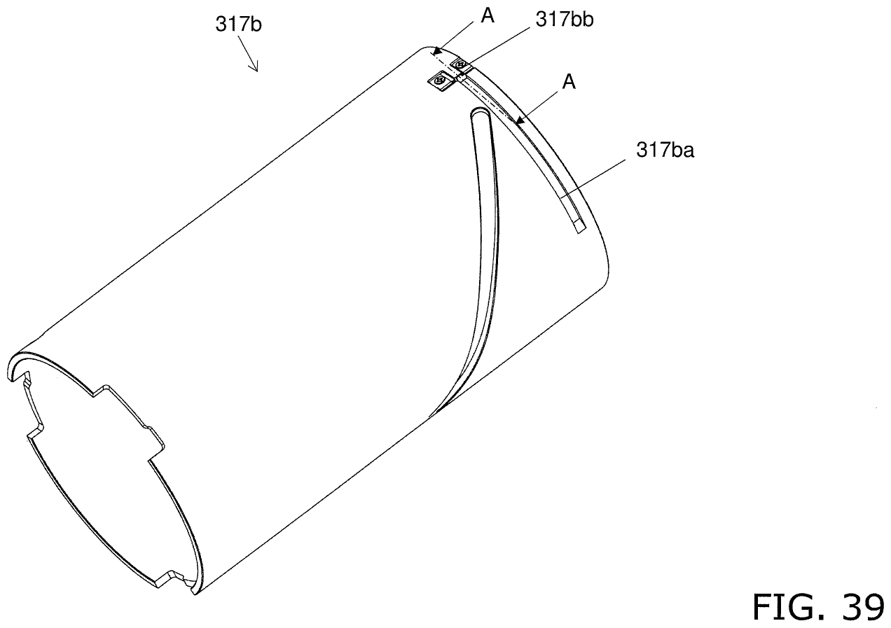

Here, the restriction member 342, which rotates around the rotating shaft 344, has one end which moves relatively within a groove 317ba formed in the outer peripheral surface of a cam barrel (rotating member) 317b (see FIG. 39) disposed on the inner peripheral surface side of the ring mount base 319.

That is, when the zoom ring unit 319b is turned, the cam barrel 317b shown in FIG. 39 rotates around the optical axis. At this point, the restriction member 342 provided on the outer peripheral surface of the ring mount base 319 moves along the groove 317ba of the cam barrel 317b.

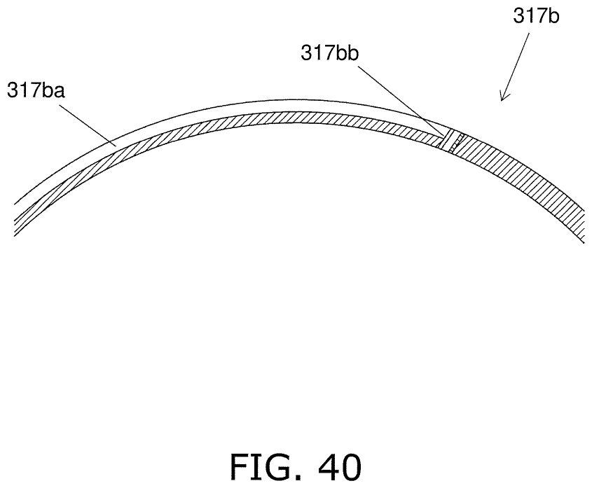

The groove 317ba of the cam barrel 317b makes contact with the restriction member 342 at the contact portion 317bb shown in FIG. 40.

This restricts the rotation of the zoom ring unit 319b beyond the position where the retractable lens frame 18b makes contact with the teleconverter 30 in a state in which the teleconverter 30 has been mounted to the lens mount unit 320a.

A reinforcing sheet metal member is fixed with screws to the contact portion 317bb with which the restriction member 342 comes into contact. This improves the strength of the contact portion 317bb on the cam barrel 317b side.

Here, when the operation portion 341a is in its ON position, the restriction member 342 is biased clockwise by the coil spring 343, and as shown in FIGS. 41A and 41B, in this state the end portion on the right side in the drawings (contact portion 342a) is in contact with the contact portion 317bb provided at the end of the groove 317ba of the cam barrel 317b disposed on the inner surface side of the ring mount base 319.

Consequently, when the operation portion 341a of the zoom limit switch 340 is in its ON state, as shown in FIG. 41B, the rotation of the cam barrel 317b is restricted by the restriction member 342, and this restricts the rotational operation of the zoom ring unit 319b.

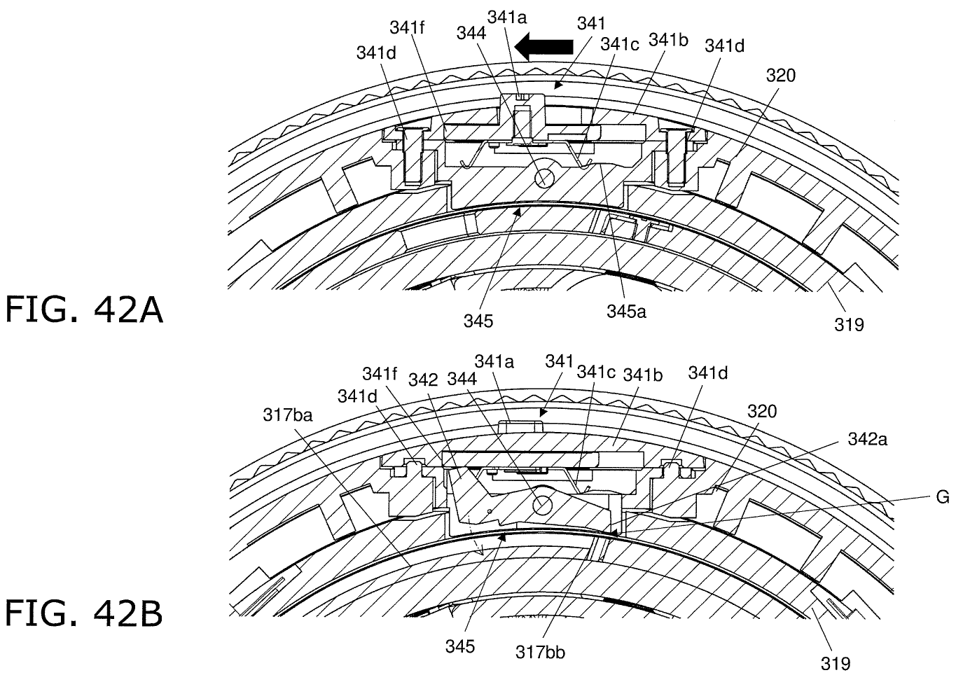

On the other hand, when the operation portion 341a is in its OFF position, the operation portion 341a moves in the direction of the arrow shown in FIG. 42A, causing the restriction member 342 to rotate against the biasing force of the coil spring 343. At this point, the contact portion 341f on the operation portion 341a side pushes in on the restriction member 342, causing the restriction member 342 to rotate counterclockwise as shown in FIG. 42B.

At this point, the contact portion 342a of the restriction member 342 is pulled upward from the groove 317ba formed in the outer peripheral surface of the cam barrel 317b, forming a gap G between the contact portion 342a and the outer peripheral surface of the cam barrel 317b, as shown in FIG. 42B.

Consequently, when the operation portion 341a of the zoom limit switch 340 is in its OFF state, the restriction on rotation of the cam barrel 317b by the restriction member 342 is released, as shown in FIG. 42B, and the zoom ring unit 319b can again rotate.

Also, in a transition from the ON state shown in FIG. 41A to the OFF state shown in FIG. 42A, one leg of leaf spring 341c rides up and over the convex portion of an uneven portion 345a provided on the upper surface of switch base 345, moving into the concave portion.

This produces a clicking sensation when the zoom limit switch 340 is switched on and off.

### Other Embodiments

Embodiments of the present disclosure were described above, but the present disclosure is not limited to or by the above embodiments, and various modifications are possible without departing from the gist of the disclosure.
(A)

In the above embodiments, an example was given in which the seventh lens group unit 18 encompassing the retractable lens frame 18b moved the retractable lens frame 18b back and forth in the optical axis X direction along the three guide shafts 18af. However, the present disclosure is not limited to this.

For example, there may be only two, or four or more guide shafts that move the retractable lens frame 18b back and forth in the optical axis X direction.

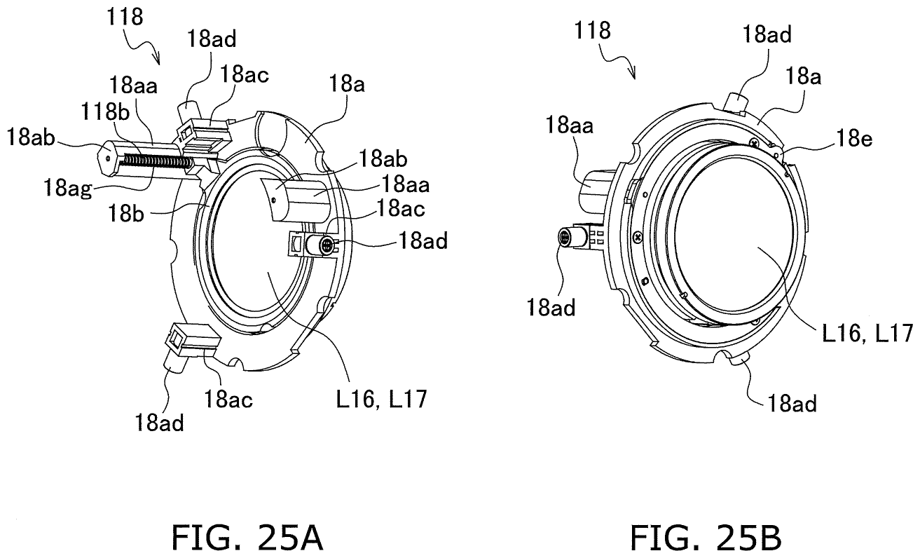

For example, as shown in FIGS. 25A and 25B, a seventh lens group unit 118 may be used in which a retractable lens frame 18b is moved back and forth in the optical axis X direction by two guide shafts, namely, a main guide shaft 118b and a sub-guide shaft 118d.

Of the components described in this embodiment (A), those having the same function and configuration as those described in the above Embodiment 1 are numbered the same as in Embodiment 1 and will not be described again in detail.

As shown in FIG. 25A, a compression spring 18ag is wound around the outer peripheral side of the main guide shaft 118b, and the outer peripheral side is covered by a housing 18aa.

The sub-guide shaft 118d is different from the main guide shaft 118b in that no compression spring 18ag is wound around the outer peripheral side, and the outer peripheral side is covered by the housing 18aa.

Therefore, with the lens barrel of this embodiment, the retractable lens frame 18b encompassed by the seventh lens group unit 118 is biased to the image plane side in the optical axis X direction by a single compression spring 18ag wound around the main guide shaft 118b. The sub-guide shaft 118d also has an anti-rotation function that restricts movement of the retractable lens frame 18b in the rotational direction around the main guide shaft 118b.

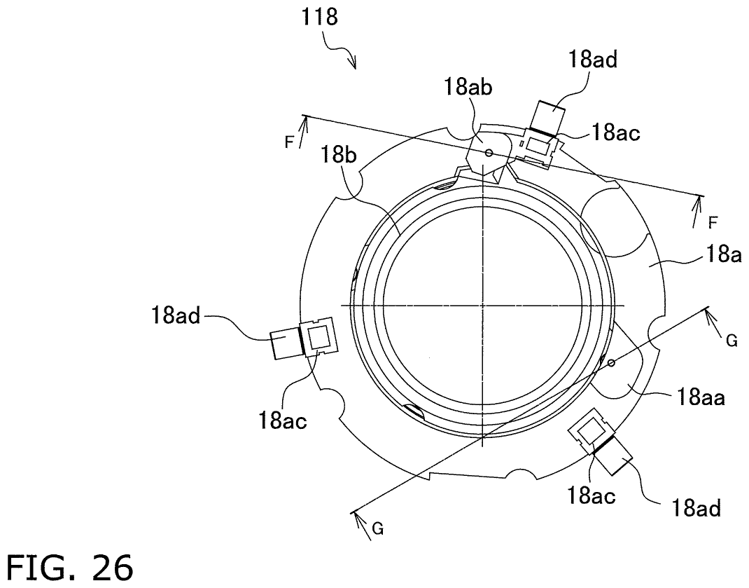

Meanwhile, in the seventh lens group unit 118, just as in Embodiment 1 above, three cam pins 18ad are provided so as to protrude outward in the radial direction at substantially equal angular intervals (approximately 120 degree intervals), as shown in FIG. 26.

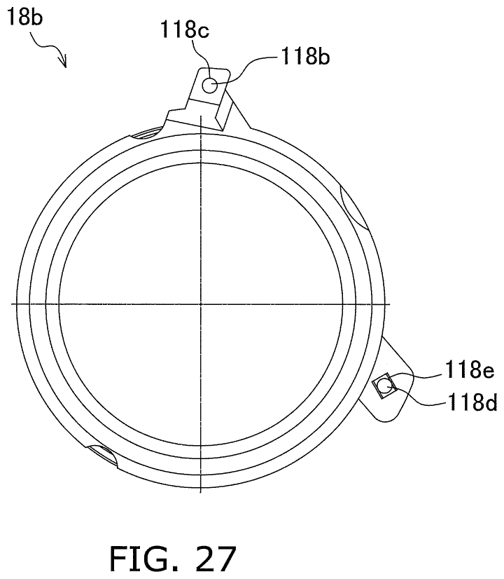

As shown in FIG. 27, the retractable lens frame 18b has a hole 118c (first hole, second hole) into which the main guide shaft 118b is inserted, and a hole 118e (second hole) into which the sub-guide shaft 118d is inserted.

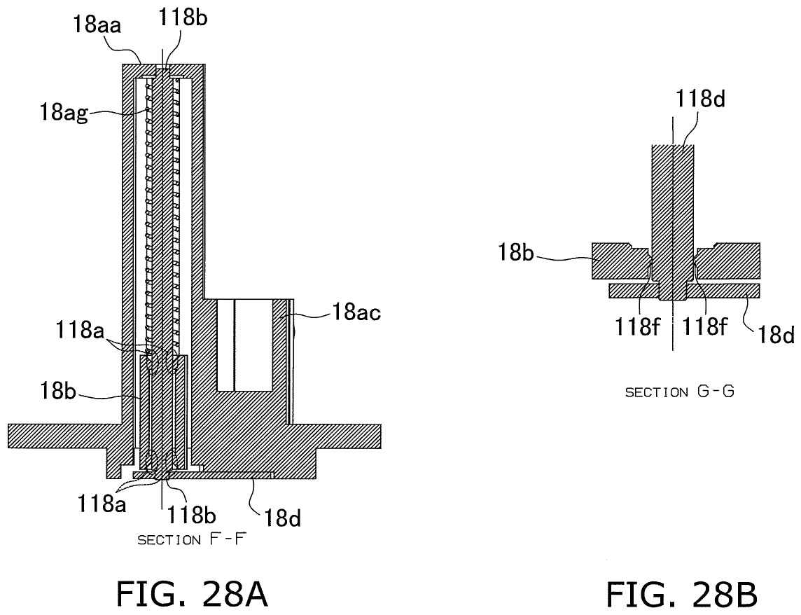

Here, as shown in FIG. 28A, the contact portion 118a that comes into contact with the outer peripheral surface of the main guide shaft 118b at two locations is provided at the position where the retractable lens frame 18b comes into contact with the main guide shaft 118b.

Since the contact portion 118a is in contact with the outer peripheral surface at two locations in the lengthwise direction of the main guide shaft 118b, this prevents problems such when as the retractable lens frame 18b becomes tilted relative to the main guide shaft 118b and is unable to move in the optical axis X direction.

It is preferable for the position where the contact portion 118a makes contact with the outer peripheral surface of the main guide shaft 118b to be as long as possible along the lengthwise direction of the main guide shaft 118b. This makes it less likely that the orientation of the retractable lens frame 18b will be disturbed, and allows the retractable lens frame 18b to move smoothly in the optical axis X direction.

Meanwhile, a thin-walled portion 118f is provided as shown in FIG. 28B at the position where the retractable lens frame 18b makes contact with the sub-guide shaft 118d.

As shown in FIG. 28B, the thin-walled portion 118f is formed so that its thickness decreases toward the sub-guide shaft 118d.

Consequently, in the configuration of the seventh lens group unit 118 in which the retractable lens frame 18b is guided in the optical axis X direction using two guide shafts, namely, the main guide shaft 118b and the sub-guide shaft 118d, it is possible to prevent problems such as when the orientation of the retractable lens frame 18b is disturbed due to contact with the retractable lens frame 18b on the sub-guide shaft 118d side, causing a jam when moving in the optical axis X direction.
(B)

In the above embodiment, an example was given in which the retractable lens frame 18b that was retracted when the teleconverter 30 was mounted was included in the seventh lens group unit 18. However, the present disclosure is not limited to this.

For example, the retractable lens frame that is retracted when the teleconverter is mounted is not limited to being included in the seventh lens group unit, and may be included in some other lens group unit.
(C)

In the above embodiment, an example was given in which the compression springs 18ag were disposed on each of the three guide shafts 18af that guided the retractable lens frame 18b in the optical axis X direction, and a biasing force was applied to the retractable lens frame 18b toward the image surface in the optical axis X direction at the positions of the three guide shafts 18af. However, the present disclosure is not limited to this.

For example, the elastic member that applies a biasing force to the retractable lens frame may be provided to only some of the guide shafts, rather than to all of the guide shafts.
(D)

In the above embodiment, an example was given in which the compression springs 18ag were used as elastic members that biased the retractable lens frame 18b toward the image plane side in the optical axis X direction. However, the present disclosure is not limited to this.

For example, some elastic member other than a compression spring may be used, so long as a biasing force is applied to the retractable lens frame.
(E)

In Embodiment 2 above, an example was given in which the ring mount base 219 was used as a fixed frame on which the zoom limit switch (rotation restriction portion) 240 was provided. However, the present invention is not limited to this.

For example, the configuration may be such that the rear frame unit 220 is used as the fixed frame, and a zoom limit switch (rotation restriction portion) is provided on the rear frame unit.
(F)

In Embodiment 2 above, an example was given in which the rotation of the cam barrel 217b was restricted by the zoom limit switch (rotation restriction portion) 240 provided on the ring mount base (fixed frame) 219. However, the present invention is not limited to this.

For example, the member whose rotation is restricted by the zoom limit switch (rotation restriction unit) 240 may be a rotating member other than the cam barrel. Alternatively, instead of restricting rotation with the zoom limit switch (rotation restriction unit) 240, the configuration may be such that the movement of a rectilinear member is restricted.

### Additional Notes

The above description of the embodiments discloses the following techniques.

### Technique 1

The lens barrel according to the first technique is:

a lens barrel that is interchangeably mounted to a camera body, the lens barrel comprising:

a mounting portion to which a teleconverter is mounted;

a retractable lens frame including an optical lens that interferes in the optical axis direction when the teleconverter is mounted;

a lens drive frame that encompasses the retractable lens frame;

three cam pins that are provided to the lens drive frame and protrude in a direction intersecting the optical axis direction;

at least two guide shafts that are provided to the lens drive frame and are disposed along the optical axis direction;

a pressing member that is attached on the image plane side of the lens drive frame and restricts movement of the retractable lens frame toward the image plane side in the optical axis direction; and

a biasing member that is attached along the guide shafts, applies a biasing force for biasing the retractable lens frame toward the pressing member in the optical axis direction, and expands and contracts when the teleconverter is mounted to the mounting portion, thereby retracting the retractable lens frame toward the subject side in the optical axis direction.

### Technique 2

The lens barrel according to the second technique is the lens barrel according to the first technique,

wherein the lens drive frame provided with the cam pins is disposed at the same position in the optical axis direction before and after the teleconverter is mounted.

### Technique 3

The lens barrel according to the third technique is the lens barrel according to the first or second technique,

wherein the biasing member is provided along each of the two or more guide shafts.

### Technique 4

The lens barrel according to the fourth technique is the lens barrel according to any of the first to third techniques,

wherein the retractable lens frame has first hole portions that are formed along the optical axis direction and into which the guide shafts are inserted, and a thin-walled portion that is opposite the outer peripheral surfaces of the guide shafts in the first hole portions and has a thickness that decreases toward the guide shafts.

### Technique 5

The lens barrel according to the fifth technique is the lens barrel according to any of the first to fourth techniques,

wherein the guide shafts each include a main guide shaft that is provided with the biasing member, and a sub-guide shaft that is not provided with the biasing member.

### Technique 6

The lens barrel according to the sixth technique is the lens barrel according to the fifth technique,

wherein the retractable lens frame has second hole portions into which the main guide shafts are inserted, and contact portions that come into contact with the main guide shafts at two points in the optical axis direction in the second hole portions.

### Technique 7

The lens barrel according to the seventh technique is the lens barrel according to any of the first to sixth techniques,

wherein the sub-guide shafts restrict the movement of the retractable lens frame in the rotation direction around the main guide shafts.

### Technique 8

The lens barrel according to the eighth technique is the lens barrel according to any of the first to seventh techniques,

wherein the pressing member supports an end portion of the guide shafts on the image plane side in the optical axis direction.

### Technique 9

The lens barrel according to the ninth technique is the lens barrel according to any of the first to eighth techniques, further comprising:

a substantially cylindrical manual operation ring that encompasses the lens drive frame and is rotated around the optical axis; and

a rotation restriction portion that rotates integrally with the manual operation ring and restricts rotational operation beyond the position where the retractable lens frame makes contact with the teleconverter in a state in which the teleconverter has been mounted to the mounting portion.

### Technique 10

The lens barrel according to the tenth technique is the lens barrel according to the ninth technique,

further comprising a substantially cylindrical base member that is mounted to the outer peripheral surface in a state in which the manual operation ring can be rotated,

wherein the rotation restriction portion has an operation portion that protrudes outward in the radial direction centered on the optical axis and switches between restriction and no restriction by the rotation restriction portion by being operated in the peripheral direction, an elastic member that biases the operation portion outward in the radial direction, and a restriction member that is provided on the inside of the operation portion in the radial direction and makes contact with part of the base member as the operation portion moves in the peripheral direction, thereby restricting the rotation range of the manual operation ring.

### Technique 11

The lens barrel according to the eleventh technique is the lens barrel according to the tenth technique,

further having a rotating shaft serving as the rotational center when the restriction member rotates along with the movement of the operation portion in the peripheral direction.

### Technique 12

The lens barrel according to the twelfth technique is the lens barrel according to the eleventh technique,

wherein the manual operation ring has a bearing portion that is integrally provided on the outer peripheral surface and supports the rotating shaft.

### Technique 13

The lens barrel according to the thirteenth technique is the lens barrel according to the twelfth technique,

wherein the elastic member is a leaf spring, and

the manual operation ring has a protrusion so that when the operation portion is operated in the peripheral direction, the leaf spring moves in the peripheral direction along with the operation portion, and the lower end portion of the leaf spring rides up and over the protrusion to generate a clicking sensation.

### Technique 14

The lens barrel according to the fourteenth technique is the lens barrel according to the tenth technique,

wherein the rotation restriction portion further has a metal member that is provided at the position where the restriction member and part of the base member come into contact with each other.

### Technique 15

The lens barrel according to the fifteenth technique is the lens barrel according to any of the first to eighth techniques, further comprising:

a fixed frame that encompasses the lens drive frame; and

a rotation restriction portion that is provided to the fixed frame and restricts the rotation of members on the rotating side beyond the position where the retractable lens frame makes contact with the teleconverter when the teleconverter has been mounted to the mounting portion.

### Technique 16

The lens barrel according to the sixteenth technique is the lens barrel according to the fifteenth technique,

further comprising a substantially cylindrical manual operation ring that encompasses the lens drive frame and is rotated around the optical axis,

wherein the fixed frame is a substantially cylindrical base member on whose outer peripheral surface is rotatably mounted the manual operation ring.

### Technique 17

The lens barrel according to the seventeenth technique is the lens barrel according to the sixteenth technique,

further comprising a substantially cylindrical cam barrel in which a cam groove is formed along a direction intersecting the optical axis direction, and that rotates around the optical axis along with the rotational operation of the manual operation ring,

wherein the rotation restriction portion has an operation portion that protrudes outward in the radial direction centered on the optical axis and switches between restriction and no restriction by the rotation restriction portion by being operated in the peripheral direction, an elastic member that biases the operation portion outward in the radial direction, and a restriction member that is provided on the inside of the operation portion in the radial direction and makes contact with part of the cam barrel as the operation portion moves in the peripheral direction, thereby restricting the rotation range of the cam barrel.

### Technique 18

The lens barrel according to the eighteenth technique is the lens barrel according to the seventeenth technique,

further having a rotating shaft serving as the rotational center when the restriction member rotates along with the movement of the operation portion in the peripheral direction.

### Technique 19

The lens barrel according to the nineteenth technique is the lens barrel according to the eighteenth technique,

wherein the fixed frame has a bearing portion that is integrally provided to the outer peripheral surface and supports the rotating shaft.

### Technique 20

The lens barrel according to the twentieth technique is the lens barrel according to the fifteenth technique,

further comprising a base member, on the radial outer surface of which the rotation restriction portion is disposed, and that is removably attached to the outer peripheral surface of the fixed frame.

### Technique 21

The lens barrel according to the twenty-first technique is the lens barrel according to the seventeenth technique,

wherein a reinforcing sheet metal member is attached to the part of the cam barrel with which the restriction member comes into contact.

### Technique 22

The camera system according to the twenty-second technique comprises:

the lens barrel according to any of techniques 1 to 21;

the teleconverter; and

a camera body to which the lens barrel and/or the teleconverter is mounted.

### INDUSTRIAL APPLICABILITY

The lens barrel of the present disclosure exhibits the effect that damage to parts and other such problems can be prevented even when a teleconverter is mounted, and is therefore widely applicable to lens barrels mounted to various kinds of camera.

### REFERENCE SIGNS LIST

10 lens barrel
11 first lens group unit
12 second lens group unit
13 third lens group unit
14 fourth lens group unit
15 fifth lens group unit
16 sixth lens group unit
16a shaft holder
17a rectilinear cam barrel
17b cam barrel
18 seventh lens group unit
18a lens drive frame
18aa housing
18ab shaft holder
18ac cam pin base
18ad cam pin
18ae fixing member
18af guide shaft
18ag compression spring (biasing member)
18b retractable lens frame
18ba guide shaft hole
18bb step portion
18c lens presser
18d pressing member
18da screw hole
18e screw
19 ring mount base (base member)
19a focus ring
19b zoom ring unit (manual operation ring)
19ba zoom ring
19bb zoom ring rubber
19bc zoom encoder brush
19bd zoom drive pin fitting hole
19c contact portion
19d zoom drive pin
20 rear frame unit
20a lens mount unit (mounting portion)
21 control board
25 zoom encoder
26 mount contact
27 teleconverter identification terminal
30 teleconverter
31 main body
32 mount contact
33 lens contact pin
34 teleconverter identification terminal
35 removal button
40 zoom limit switch (rotation restriction part)
40a switch installation portion
41 switch unit
41a operation portion
41b cover
41c leaf spring (elastic member)
41d fixing screw
41e fixing screw
41f contact portion
42 restriction member
42a contact portion
43 coil spring
44 rotating shaft
45 bearing portion
46a convex portion
46b concave portion
47 metal plate (metal member)
48a sliding surface
48b sliding surface
49 restriction member housing portion
50 camera body
51 control board
52 display panel
53 contact pin
100 camera system
118 seventh lens group unit
118a contact portion
118b main guide shaft
118c hole (first hole, second hole)
118d sub-guide shaft
118e hole (second hole)
118f thin-walled portion
210 lens barrel
211 first lens group unit
217b cam barrel (rotating member)
217ba groove
217bb contact portion
219 ring mount base (fixed frame, base member)
219b zoom ring unit (manual operation ring)
220 rear frame unit
220a lens mount unit
220b light shielding frame
240 zoom limit switch (rotation restriction portion)
241 switch unit
241a operation portion
241b cover
241c leaf spring (elastic member)
241d fixing screw
241f contact portion
242 restricting member
242a contact portion
243 coil spring
244 rotating shaft
245 bearing portion
310 lens barrel
311 first lens group unit
317b cam barrel (rotating member)
317ba groove
317bb contact portion
319 ring mount base (fixed frame, base member)
320 rear frame unit
340 zoom limit switch (rotation restriction portion)
341 switch unit
341a operation portion
341b cover
341c leaf spring (elastic member)
341d fixing screw
342 restricting member
342a contact portion
343 coil spring
344 rotating shaft
345 switch base (base member)
345a uneven portion
G gap
L1 to L17 lenses (optical lenses)
L31 to L36 lenses
X optical axis

What is claimed is:

1. A lens barrel that is interchangeably mounted to a camera body, the lens barrel comprising:
a mounting portion to which a teleconverter is mounted;
a retractable lens frame including an optical lens configured to interfere in an optical axis direction when the teleconverter is mounted;
a lens drive frame that encompasses the retractable lens frame;
three cam pins that are provided to the lens drive frame and protrude in a direction intersecting the optical axis direction;
at least two guide shafts that are provided to the lens drive frame and are disposed along the optical axis direction;
a pressing member that is attached on an image plane side of the lens drive frame and is configured to restrict movement of the retractable lens frame toward the image plane side in the optical axis direction; and
a biasing member that is attached along the guide shafts, configured to apply a biasing force for biasing the retractable lens frame toward the pressing member in the optical axis direction, and configured to expand and contract when the teleconverter is mounted to the mounting portion, thereby retracting the retractable lens frame toward a subject side in the optical axis direction.

2. The lens barrel according to claim 1,
wherein the lens drive frame provided with the cam pins is disposed at the same position in the optical axis direction before and after the teleconverter is mounted.

3. The lens barrel according to claim 1,
wherein the biasing members are provided along each of the two or more guide shafts.

4. The lens barrel according to claim 1,
wherein the retractable lens frame has first hole portions that are formed along the optical axis direction and into which the guide shafts are inserted, and a thin-walled portion that is opposite an outer peripheral surfaces of the guide shafts in the first hole portions and has a thickness that decreases toward the guide shafts.

5. The lens barrel according to claim 1,
wherein the guide shafts each include a main guide shaft that is provided with the biasing member, and a sub-guide shaft that is not provided with the biasing member.

6. The lens barrel according to claim 5,
wherein the retractable lens frame has second hole portions into which the main guide shafts are inserted, and contact portions configured to come into contact with the main guide shafts at two points in the optical axis direction in the second hole portions.

7. The lens barrel according to claim 5,
wherein the sub-guide shafts restrict the movement of the retractable lens frame in a rotation direction around the main guide shafts.

8. The lens barrel according to claim 1,
wherein the pressing member supports an end portion of the guide shafts on the image plane side in the optical axis direction.

9. The lens barrel according to claim 1, further comprising:
a substantially cylindrical manual operation ring that encompasses the lens drive frame and is rotated around the optical axis; and
a rotation restriction portion configured to rotate integrally with the manual operation ring and restrict a rotational operation beyond a position where the retractable lens frame makes contact with the teleconverter in a state in which the teleconverter has been mounted to the mounting portion.

10. The lens barrel according to claim 9,
further comprising a substantially cylindrical base member that is mounted to an outer peripheral surface in a state in which the manual operation ring can be rotated,
wherein the rotation restriction portion has an operation portion that protrudes outward in a radial direction centered on the optical axis and is configured to switch between restriction and no restriction by the rotation restriction portion by being operated in a peripheral direction, an elastic member configured to bias the operation portion outward in the radial direction, and a restriction member that is provided on an inside of the operation portion in the radial direction and is configured to make contact with part of the base member as the operation portion moves in the peripheral direction, thereby restricting a rotation range of the manual operation ring.

11. The lens barrel according to claim 10,
further having a rotating shaft serving as a rotational center when the restriction member rotates along with a movement of the operation portion in the peripheral direction.

12. The lens barrel according to claim 11,
wherein the manual operation ring has a bearing portion that is integrally provided on an outer peripheral surface and supports the rotating shaft.

13. The lens barrel according to claim 12,
wherein the elastic member is a leaf spring, and
the manual operation ring has a protrusion so that when the operation portion is operated in a peripheral direction, the leaf spring moves in the peripheral direction along with the operation portion, and a lower end portion of the leaf spring rides up and over the protrusion to generate a clicking sensation.

14. The lens barrel according to claim 10,
wherein the rotation restriction portion further has a metal member that is provided at a position where the restriction member and a part of the base member come into contact with each other.

15. The lens barrel according to claim 1, further comprising:
a fixed frame that encompasses the lens drive frame; and
a rotation restriction portion that is provided to the fixed frame and is configured to restrict a rotation of a rotating side members beyond the position where the retractable lens frame makes contact with the teleconverter when the teleconverter has been mounted to the mounting portion.

16. The lens barrel according to claim 15,
further comprising a substantially cylindrical manual operation ring that encompasses the lens drive frame and is rotated around the optical axis,
wherein the fixed frame is a substantially cylindrical base member on whose outer peripheral surface is rotatably mounted the manual operation ring.

17. The lens barrel according to claim 16,
further comprising a substantially cylindrical cam barrel in which a cam groove is formed along a direction intersecting the optical axis direction, and that is configured to rotate around the optical axis along with a rotational operation of the manual operation ring,
wherein the rotation restriction portion has an operation portion that protrudes outward in a radial direction centered on the optical axis and is configured to switch between restriction and no restriction by the rotation restriction portion by being operated in a peripheral direction, an elastic member configured to bias the operation portion outward in the radial direction, and a restriction member that is provided on an inside of the operation portion in the radial direction and is configured to make contact with part of the cam barrel as the operation portion moves in the peripheral direction, thereby restricting a rotation range of the cam barrel.

18. The lens barrel according to claim 17,
further having a rotating shaft serving as a rotational center when the restriction member rotates along with a movement of the operation portion in the peripheral direction.

19. The lens barrel according to claim 18,
wherein the fixed frame has a bearing portion that is integrally provided to an outer peripheral surface and is configured to support the rotating shaft.

20. The lens barrel according to claim 15,
further comprising a base member, on an outer surface in a radial direction of which the rotation restriction portion is disposed, and that is removably attached to an outer peripheral surface of the fixed frame.

21. The lens barrel according to claim 17,
wherein a reinforcing sheet metal member is attached to a part of the cam barrel with which the restriction member comes into contact.

22. A camera system, comprising:
the lens barrel according to claim 1;
the teleconverter; and
a camera body to which the lens barrel and/or the teleconverter is mounted.
